(19) United States
(12) Patent Application Publication
(10) Pub. No.: US 2026/0289125 A1
(43) Pub. Date: Sep. 24, 2026

(54) SYSTEM

(71) Applicant: SoftBank Group Corp., Tokyo (JP)

(72) Inventor: Mugihiko FUJII, Tokyo (JP)

(73) Assignee: SoftBank Group Corp., Tokyo (JP)

(21) Appl. No.: 19/567,403

(22) Filed: Mar. 16, 2026

(30) Foreign Application Priority Data
Mar. 19, 2025 (JP) 2025-045084

(51) Int. Cl. G06F 40/284; G06F 18/243

(52) U.S. Cl. CPC G06F 40/284; G06F 18/24323

(57) ABSTRACT

A system includes a processor that is configured to collect personal information of a user, analyze the collected personal information, and generate a prompt for input to a generative AI model based on the analyzed information.

### CROSS-REFERENCE TO RELATED APPLICATION

This application is based on and claims priority under 35 USC 119 from Japanese Patent Application No. 2025-045084 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for generating proposals or recommendations using artificial intelligence often rely on static or limited user inputs and do not dynamically construct prompts tailored to a specific generative AI model based on a comprehensive analysis of personal information. As a result, the generated content may be generic, may not sufficiently reflect an individual user's body type, preferences, living environment, or situational context such as season, location, time, and event, and may therefore fail to provide proposals that are highly relevant or personalized to the user. Furthermore, existing systems frequently do not provide an integrated mechanism that, in a unified flow, acquires detailed personal information, analyzes such information to construct an optimized prompt for a generative AI model, and then delivers the resulting proposals to the user's terminal over a network for online presentation. Consequently, there is a need for a system that can automatically collect and analyze user personal information, generate a context-aware prompt for a generative AI model based on the analyzed information, and present the generated proposals to the user in an online environment.

### SUMMARY

In order to solve the above-described problems, according to one embodiment, there is provided a system comprising a processor, wherein the processor is configured to collect personal information of a user, analyze the collected personal information, and generate a prompt for input to a generative AI model based on the analyzed information. In one aspect, the processor is configured to generate the prompt so as to instruct the generative AI model to create a proposal by taking into account at least one of information regarding a body type of the user, a preference of the user, a living environment of the user, a season, a location, a time, and an event, thereby enabling generation of proposals that are adapted to both the characteristics of the user and the current or planned context. In another aspect, the processor is configured to transmit data to a terminal of the user via the Internet so as to present, online, a proposal generated by the generative AI model to the user, whereby the user can view and utilize the personalized proposal in real time through the user's own terminal.

The term “system” refers to an arrangement of one or more hardware and software components that collectively perform the functions described in the present specification, including at least one processor and optionally memory, storage, communication interfaces, and other peripheral devices.

The term “processor” refers to any hardware device or combination of devices configured to execute instructions, such as a central processing unit (CPU), a graphics processing unit (GPU), a digital signal processor (DSP), a microcontroller, or a combination thereof, and may include one or more processing cores operating in a distributed or centralized manner. The term “personal information” refers to information related to a specific user, including but not limited to body type, preferences, living environment, season, location, time, event, and any other data that can be used to characterize the user or the user's circumstances for the purpose of generating a proposal.

The term “user” refers to an individual person who provides personal information, for whom a proposal is generated, and who views or utilizes the proposal via a terminal.

The term “analyze” or “analyzing” refers to performing one or more computational operations on collected personal information, such as classification, clustering, extraction of features, weighting, filtering, or other processing, in order to derive parameters or attributes used to generate a prompt for a generative AI model.

The term “prompt” refers to data, including text, structured data, or a combination thereof, that is provided as input to a generative AI model to control or influence the content, style, or format of an output generated by the generative AI model.

The term “generative AI model” refers to a machine learning model, such as a neural network or other statistical model, that is configured to generate content, including but not limited to text, images, audio, or other data, in response to an input prompt.

The term “proposal” refers to information or content generated by the generative AI model based on a prompt, including but not limited to recommendations, suggestions, plans, or other outputs that are intended to be presented to the user.

The term “terminal” refers to an electronic device operated by the user, such as a smartphone, tablet, personal computer, or any other network-connected device, that is capable of receiving data via the Internet and displaying or otherwise outputting information to the user.

The term “Internet” refers to a global network of interconnected communication networks that use standardized communication protocols to transmit data between the system and the terminal.

The term “body type” refers to information regarding the physical constitution or shape of the user, such as slim, average, plus size, height, weight, or other attributes relevant to generating a proposal.

The term “preference” refers to information indicating the user's likes, dislikes, tastes, or tendencies, including but not limited to style preferences, color preferences, or usage preferences that influence the generation of a proposal.

The term “living environment” refers to conditions related to the user's everyday surroundings, such as climate, typical temperature, urban or rural setting, or lifestyle circumstances, that may affect the suitability of a proposal.

The term “season” refers to a temporal classification such as spring, summer, autumn, or winter, or any equivalent period, which may influence the content of a proposal.

The term “location” refers to a geographical position or area associated with the user, such as a city, region, or country, which may be used as contextual information when generating a proposal.

The term “time” refers to temporal information associated with the user or the proposal, such as time of day, date, or specific time period, that may affect the appropriateness of a proposal.

The term “event” refers to a particular occasion or situation relevant to the user, such as a business meeting, office work, a party, a wedding, a casual outing, or any other context for which a proposal may be generated.

The term “online” refers to a state in which the terminal and the system are connected via the Internet such that data, including proposals, can be transmitted and presented in real time or near real time.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

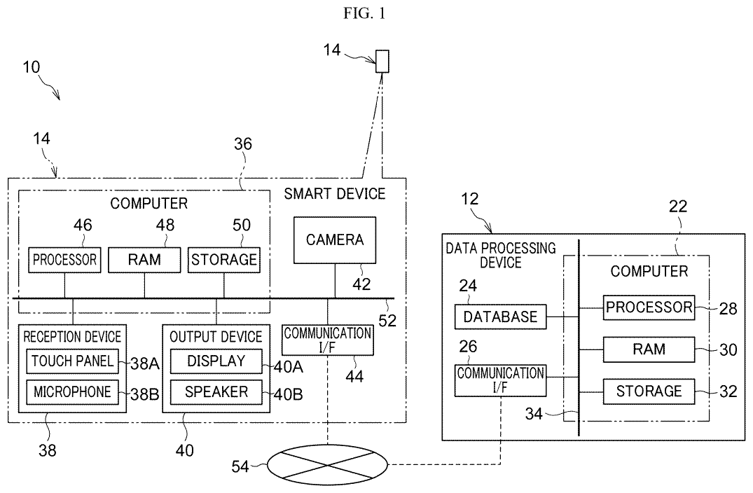

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

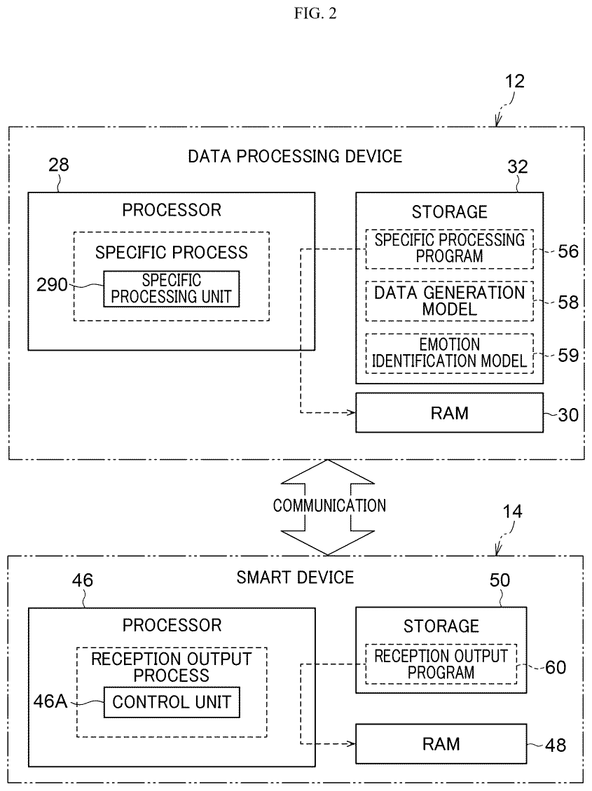

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional recommendation systems that utilize user information and machine learning models often rely on static, coarse-grained user profiles and fixed rule sets. Such systems typically perform limited preprocessing of user-input data and external data, and they generate generic commands to machine learning models without taking into account detailed user behavior patterns or the specific input-output requirements of a generative AI model. As a result, these systems frequently produce recommendations that are not sufficiently tailored to the user's actual preferences and usage context, and they may require extensive manual tuning of prompts and post-processing logic.

Further, in many existing architectures, unstructured text data obtained from external information sources, such as online services and social platforms, is not systematically normalized, analyzed, and converted into robust feature quantity information that can drive adaptive prompt generation. This lack of structured processing leads to underutilization of rich behavioral signals contained in user text data, and limits the ability of the system to automatically refine and optimize its interaction with a generative AI model.

Additionally, when generative AI models are invoked, existing systems often send informal or weakly constrained prompts that do not specify a desired structured data format or explicit constraints for the output. Consequently, the returned results may be inconsistent in structure, difficult to parse by downstream components, and costly to integrate into automated user interface flows. These limitations degrade the overall efficiency, robustness, and scalability of computer-based recommendation pipelines, and place a heavy burden on developers to implement ad hoc parsing and error handling.

Accordingly, there is a need for an improved computer-implemented system that (i) systematically collects and stores heterogeneous user attribute information including external public information, (ii) applies statistical processing and natural language processing to derive feature quantity information representing user preferences and behavior patterns, (iii) dynamically generates and controls prompt sentences for a generative AI model based on learned behavioral pattern categories, and (iv) specifies and processes structured output formats and constraint conditions so that generated proposal information can be reliably filtered, enriched, and delivered to user terminal devices. Such a system should improve the technical functioning of the recommendation pipeline and the interaction between application logic and the generative AI model.

The specific processing by the specific processing unit 290 of the data processing device 12 in Example 1 is realized by the following means.

The present invention provides a server comprising a processor, a memory, and a communication interface, the processor being configured to acquire, via a communication network, user attribute information including input information from a user and public information obtained through an external information providing apparatus, store the user attribute information in the memory, perform, by using a statistical processing program and a natural language processing program, normalization processing of character information, extraction processing of feature terms, and aggregation processing of occurrence frequency on the user attribute information stored in the memory to generate feature quantity information indicating preferences of the user, classify the user into a plurality of behavioral pattern categories by using the feature quantity information through rule-based processing or machine learning processing, construct, on a basis of the feature quantity information and the behavioral pattern categories and by using template information and control conditions, a prompt sentence including a situation description relating to the user, proposal generation conditions, output specification information, and constraint condition information, the prompt sentence being for input to a generative AI model, transmit, via the communication interface, inquiry information including the prompt sentence to an information processing service that provides the generative AI model, acquire, from the information processing service, proposal information generated in response to the prompt sentence in a structured data format specified by the output specification information and the constraint condition information, perform filter processing and supplementary information addition processing on the proposal information represented in the structured data format, convert the processed proposal information into a display format corresponding to a terminal apparatus of the user, and transmit the converted proposal information to the terminal apparatus via the communication network. This enables an improved computer-implemented recommendation mechanism in which the server automatically derives behavior-based feature quantity information from heterogeneous user attribute information, adaptively generates and constrains prompt sentences for the generative AI model based on behavioral pattern categories, reliably obtains structured proposal information suitable for deterministic programmatic processing, and efficiently transforms and delivers such proposal information to user terminal devices, thereby enhancing the technical performance, scalability, and robustness of the overall recommendation pipeline.

The term “user attribute information” refers to information relating to a user, including but not limited to information directly input by the user through an input interface and public information obtained from one or more external information providing apparatuses, such as network-based information sources, the information encompassing at least profile data, behavioral data, and text data associated with the user.

The term “external information providing apparatus” refers to an information processing apparatus or service, accessible via a communication network, that provides public or semi-public data relating to a user, such as content distribution services, social platforms, or other network-based information sources, and that can be accessed by the server through an application programming interface or other data access mechanism.

The term “communication network” refers to a wired or wireless data communication infrastructure, including but not limited to local area networks, wide area networks, and public packet-switched networks, through which data is exchanged between the server, external information providing apparatuses, and terminal apparatuses.

The term “memory” refers to one or more storage devices, including volatile storage and non-volatile storage, that are configured to store programs and data for access and use by a processor, including storage of user attribute information, feature quantity information, prompt sentences, and proposal information.

The term “statistical processing program” refers to a software component executed by a processor that performs numerical operations, aggregation operations, and statistical analysis on data, including operations for counting occurrences, computing frequencies, and deriving statistical measures from user attribute information.

The term “natural language processing program” refers to a software component executed by a processor that processes character information or text information, including but not limited to tokenization, normalization, part-of-speech tagging, feature term extraction, and other linguistic analysis, to derive structured representations from unstructured text.

The term “normalization processing of character information” refers to processing that standardizes text data, including but not limited to converting character sets, unifying letter case, removing predetermined symbols or control characters, and transforming the text into a consistent format suitable for subsequent analysis.

The term “feature term” refers to a term, token, or phrase identified within text data that is determined to be characteristic of a user's preferences, behaviors, or contexts, and that is used for computing feature quantity information and for inferring behavioral patterns.

The term “aggregation processing of occurrence frequency” refers to processing that counts and summarizes how often one or more feature terms or attributes occur within user attribute information, and that produces numerical values or distributions representing such occurrences.

The term “feature quantity information” refers to numerical or symbolic data derived from user attribute information, including but not limited to frequencies, scores, and metrics, that quantitatively represent user preferences, tendencies, and behaviors, and that are used as inputs for classification and prompt generation.

The term “behavioral pattern category” refers to a classification label or group that represents a type of user behavior or preference pattern, determined on the basis of feature quantity information by rule-based processing or machine learning processing, and used for controlling the configuration of prompt sentences and output formats.

The term “rule-based processing” refers to processing in which predetermined logical rules or conditions, defined by a designer or system administrator, are applied to feature quantity information or other data to derive inferences, classifications, or control decisions without model training.

The term “machine learning processing” refers to processing in which a trained computational model, obtained by training on sample data, is applied to feature quantity information or other input data to perform tasks such as classification, clustering, or prediction in order to infer behavioral pattern categories or other attributes.

The term “template information” refers to data that defines a structure or pattern for constructing text or messages, including fixed text segments and placeholders for variable elements, which is used by the processor to generate prompt sentences by inserting feature quantity information, behavioral pattern categories, and other contextual data.

The term “control conditions” refers to parameters, rules, or constraints that govern how a prompt sentence is constructed or how a generative AI model is invoked, including conditions relating to content selection, level of detail, output format, and other behavioral aspects of the system.

The term “prompt sentence” refers to a text sequence or set of text instructions generated by the processor and intended as input to a generative AI model, the text including at least a situation description relating to the user, proposal generation conditions, and optionally output specification information and constraint condition information.

The term “generative AI model” refers to a machine learning model configured to generate text, structured data, or other content in response to input information, such as a large-scale language model or similar generative model, which produces proposal information based on a prompt sentence.

The term “inquiry information” refers to data transmitted from the server to an information processing service that provides a generative AI model, the data including at least a prompt sentence and optionally additional control parameters for content generation.

The term “information processing service” refers to a remote or local service, implemented by one or more information processing apparatuses, that provides access to a generative AI model via an interface, and that receives inquiry information and returns generated proposal information.

The term “proposal information” refers to information generated by a generative AI model in response to a prompt sentence, including text or structured data representing recommendations, suggestions, or other outputs intended to be presented to a user.

The term “output specification information” refers to information included in a prompt sentence that instructs a generative AI model regarding a desired output format, structure, or representation, such as a specification to output data in a particular structured data format or schema.

The term “constraint condition information” refers to information included in a prompt sentence that specifies conditions or limitations on generated output, including but not limited to constraints on content type, length, domain, or other aspects of the proposal information.

The term “structured data format” refers to a data representation having an explicit structure or schema, such as records, fields, or arrays, that can be deterministically parsed and processed by a program, and that is distinct from free-form natural language text.

The term “filter processing” refers to processing performed on proposal information in a structured data format to select, exclude, or modify elements based on predetermined criteria, such as relevance to a user's location, preferences, or constraints.

The term “supplementary information addition processing” refers to processing in which additional data is appended or combined with proposal information, such as adding identifiers, links, metadata, or context information that enhances the usefulness or interpretability of the proposal information.

The term “display format” refers to a representation of proposal information that is adapted to the capabilities, layout, and user interface requirements of a terminal apparatus, including but not limited to arrangement of fields, text length, and visual structure.

The term “terminal apparatus” refers to an information processing device used by a user to access services provided by the server, including but not limited to portable information terminals, stationary information terminals, and other computing devices configured to receive and display data via a communication network.

In one embodiment, a server includes a processor, a memory, a non-volatile storage device, and a communication interface. The server is connected via a communication network to one or more terminal devices operated by users and to one or more external information providing apparatuses. The server is further connected to an information processing service that provides a generative AI model. The terminal includes a display, an input interface, a wireless or wired communication module, and a local storage region for application data. The server executes an operating system, such as a general-purpose server operating system, and middleware including a web server and an application server. On top of this environment, the server executes application software implemented, for example, in a programming language interpreter and using libraries for data processing and natural language processing. The server uses a relational database management system as the memory for persistent storage of user attribute information, feature quantity information, behavioral pattern categories, prompt sentences, and proposal information.

The user operates the terminal to install and launch a dedicated application or to access a web-based interface. The terminal executes a client program implemented using a user interface framework, and displays input screens that prompt the user to enter attribute information. The user inputs profile data including physical characteristics, general preferences, and environmental information. The terminal converts the input into structured data and transmits it to the server via the communication network using a secure communication protocol.

The server stores the received user attribute information in the database using structured records. The server associates each record with a user identifier and with metadata such as timestamps, data sources, and language codes. The server also stores access tokens or identifiers for external information providing apparatuses that maintain public or semi-public data related to the user.

The server periodically or on demand accesses one or more external information providing apparatuses via application programming interfaces. The server uses a communication interface and a network protocol to send requests that include the user identifiers and authentication data. The external information providing apparatus responds with data that includes text posts, interaction records, or other behavioral traces. The server receives the data as structured messages and stores them in tables or collections in the database, preserving the association with the corresponding user.

The server uses a statistical processing program and a natural language processing program to process the user attribute information stored in the database. The server performs normalization processing of character information, including conversion of character encoding, normalization of case, removal or mapping of special symbols, and unification of date and numeric formats. The server performs tokenization of text fields, removes stop words, and transforms inflected forms into base forms when applicable. The server thereby converts heterogeneous text data from multiple sources into a unified internal representation. The server uses the natural language processing program to extract feature terms from the normalized text. The server maintains domain-specific vocabularies and patterns for identifying terms related to activities, locations, objects, and preferences. For example, the server identifies terms corresponding to cafes, travel, quiet environments, work-related activities, and similar concepts. The server computes occurrence frequencies for each feature term per user, per time window, and per context category. The server aggregates these counts to produce feature quantity information, such as frequency ratios, co-occurrence metrics, and temporal trend indicators.

The server stores the feature quantity information in dedicated data structures, such as feature vectors represented as sequences of numerical values aligned with a predefined feature index. In some embodiments, the server applies dimensionality reduction or normalization to these vectors to improve numerical stability and to facilitate further processing. The server thereby converts raw textual behavior data into compact, machine-tractable representations. The server further uses rule-based processing or machine learning processing to classify the user into one or more behavioral pattern categories. In one example, the server uses a supervised learning model, such as a neural network or a tree-based classifier, trained on historical feature vectors and known user categories. The server loads the parameters of the model from storage into memory and applies the model to the current feature quantity information for each user. In another example, the server performs clustering using an unsupervised learning algorithm and later maps clusters to behavioral pattern categories. In a specific implementation of the generative AI model, the information processing service uses a neural network configured as a multi-layer transformer architecture. The neural network includes a plurality of layers, each layer comprising multi-head self-attention sublayers and feed-forward sublayers. The model parameters (weights and biases) are obtained by pre-training on large text corpora and optionally fine-tuned on domain-specific data. The information processing service uses a loss function, such as a cross-entropy loss, during training, and updates the weights using an optimization algorithm such as stochastic gradient descent with momentum or adaptive gradient methods. The server does not perform the training itself but interacts with the information processing service by sending prompt sentences and receiving generated outputs.

The server constructs a prompt sentence tailored to the generative AI model by combining template information, control conditions, feature quantity information, and behavioral pattern categories. The server uses text templates that contain fixed segments and placeholders. The server fills the placeholders with values derived from feature quantity information and with labels corresponding to behavioral pattern categories. The server includes in the prompt sentence explicit output specification information that instructs the generative AI model to return proposal information in a structured form, such as an enumerated list with defined fields. The server also includes constraint condition information, such as a maximum number of items, geographical constraints, and preference constraints.

For example, the server may generate a prompt sentence such as:

“The user is a 30-year-old person living in a dense urban area. The user frequently visits new specialty coffee cafes and often posts about quiet places suitable for remote work. The user dislikes crowded and noisy environments and prefers modern interiors, stable wireless connectivity, and high-quality espresso drinks. Based on this profile, act as a local cafe expert. Suggest three specific cafes in the user's city that match these preferences. For each cafe, provide: (1) name, (2) nearest public transportation station, (3) short description of the atmosphere, and (4) a brief explanation of why this cafe suits the user. Output the result as a clearly structured list with separate lines for each field.”

In another example, the server may generate a prompt sentence such as:

“The user enjoys visiting new cafes in large cities and frequently travels on weekends. The user often mentions quiet side streets and scenic neighborhoods in text posts. The user prefers relaxed environments over tourist crowds. Based on these preferences, recommend two weekend destinations within three hours by public transportation from the user's home city, and for each destination suggest one cafe that fits the user's taste. For each destination and cafe pair, describe: (1) the destination, (2) the cafe name, (3) the main reason it matches the user's preferences, and (4) an example of an activity the user could enjoy there.”

The server transmits the prompt sentence to the information processing service via the communication interface. The server includes in the transmitted data control parameters such as the desired maximum length of the generated text and the degree of variability. The information processing service applies the generative AI model to the prompt sentence and generates proposal information in accordance with the specified structure and constraints. The server receives the proposal information as structured text and parses it according to the expected format.

The server performs filter processing on the structured proposal information to enforce additional technical constraints. For instance, the server checks each proposed item against location data stored in the database, discards items that are outside a specified distance range, and removes entries that do not conform to formatting rules. The server then performs supplementary information addition processing by attaching metadata such as unique identifiers, links to mapping services, and localized labels. The server thereby converts the generative AI model's output into data structures that can be consumed deterministically by downstream components.

The server converts the processed proposal information into a display format appropriate for the terminal. The server selects layout templates and content density based on terminal capabilities, such as screen size and supported input methods. The server then transmits the display-formatted data to the terminal via the communication network. The terminal receives the data, parses it, and renders a user interface that allows the user to view, scroll, and interact with the proposal information.

The terminal may present additional controls for saving, dismissing, or requesting refinement of the recommendations. When the user operates these controls, the terminal sends feedback events to the server. The server stores the feedback events in the database as supplemental feature information and, in some embodiments, uses this information to refine the statistical processing or to adjust parameters used in generating future prompt sentences. This feedback loop improves the long-term accuracy and relevance of recommendations.

The described configuration yields a technical improvement in computer-based recommendation processing. By converting heterogeneous user attribute information into feature quantity information using structured statistical and natural language processing pipelines, the server reduces the volume and redundancy of data that must be transmitted to and from the information processing service. This reduces communication load and enables faster response times. The explicit representation of user behavior in feature vectors and behavioral pattern categories allows the server to generate more specific and constrained prompt sentences, which leads to more consistent structured outputs from the generative AI model. As a result, the server reduces the need for complex and error-prone post-hoc free-text parsing, thereby improving computing efficiency and decreasing processing errors.

Moreover, the server uses non-conventional combinations of rule-based processing, machine learning processing, and template-based prompt construction to control how the generative AI model is invoked. Instead of merely automating a human's manual prompt writing, the server dynamically adapts the content and structure of the prompt sentence based on quantitative behavior measures and categorical user profiles. This systematic adaptation, together with explicit output specification information and constraint condition information, improves the technical interaction between the application logic and the generative AI model and yields outputs that can be reliably integrated into downstream programmatic workflows.

The technical effects include improved processing speed, because the server performs pre-aggregation and feature extraction locally and sends compact, well-structured prompts to the generative AI model; improved accuracy, because the server leverages statistically derived behavioral patterns rather than coarse static profiles; and improved robustness, because the system reduces ambiguity in both input and output of the generative AI model. These improvements relate directly to the internal functioning of the server, the structure of stored data, the control of network communication, and the deterministic integration of generated content, and therefore extend beyond a mere automation of human mental tasks.

In alternative embodiments, the server may employ different types of generative AI models, such as sequence-to-sequence recurrent neural networks, convolutional sequence models, or smaller transformer models running locally. In some configurations, the server may host the generative AI model on dedicated accelerator hardware, such as a graphics processing unit or specialized inference hardware, and may execute the model using a machine learning framework. The core procedure of constructing structured prompt sentences with explicit output specifications and constraints, generating proposal information using the generative AI model, and performing deterministic post-processing remains the same.

In still other embodiments, the terminal may perform part of the natural language processing, such as initial tokenization or on-device caching of frequently used patterns, to reduce latency and server load. The server, however, remains responsible for maintaining the central feature quantity information, performing classification into behavioral pattern categories, constructing prompt sentences for the generative AI model, and integrating proposal information into the database and user interface flows. These various embodiments demonstrate that the invention can be implemented using different hardware and software configurations while maintaining the essential technical features of structured feature extraction, behavior-based prompt generation, constrained generative AI interaction, and deterministic, structured integration of generated proposal information into terminal displays.

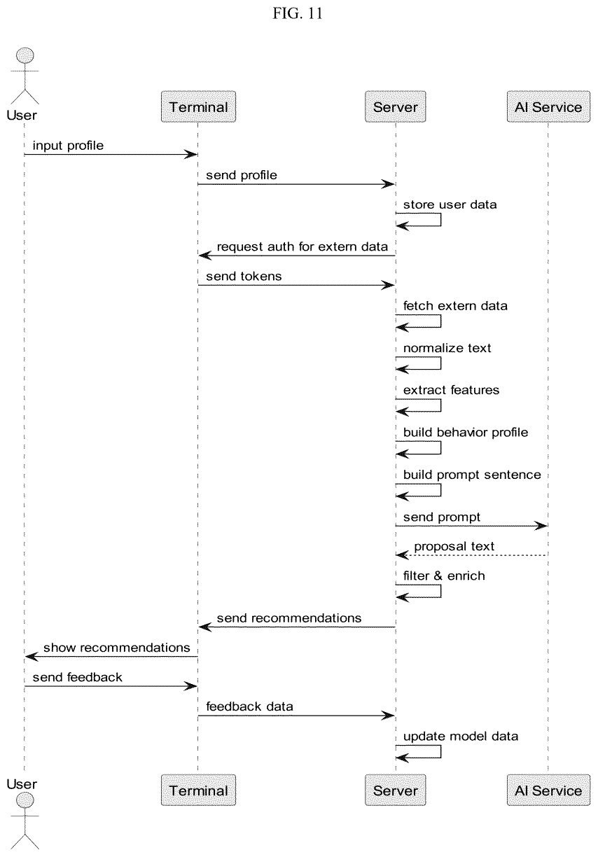

The following describes the processing flow using FIG. 11.

### Step 1

The user operates the terminal to start an application or access a web page and to input profile information. The user enters items such as age range, general body type, preferred activities, and living environment into input fields displayed on the terminal. The terminal receives these values as raw text and numeric entries and performs client-side validation, such as checking required fields and verifying that numeric values fall within allowable ranges. As input, the terminal takes user keystrokes and touch events, and as output, the terminal generates a structured data object representing the user attribute information and stores it in a temporary memory area for transmission.

### Step 2

The terminal converts the locally stored user attribute information into a structured message and transmits the message to the server. As input, the terminal uses the structured data object generated in Step 1. The terminal maps each field (for example, “preferred activity” or “home area type”) to a key in a key-value structure, encodes the structure into a string format, and sends it to the server via a communication protocol. As output, the terminal produces a network packet containing the encoded user attribute information and transfers the packet to the communication network.

Step 3

The server receives the network packet from the terminal and extracts the user attribute information. As input, the server takes the encoded message delivered through the communication interface. The server decodes the message, verifies integrity and authentication tokens, and converts the data into internal record structures with fields such as user identifier, attribute values, and timestamps. As output, the server generates normalized records and stores them in a database table dedicated to user attribute information.

### Step 4

The server accesses one or more external information providing apparatuses to obtain additional user-related public information. As input, the server uses the stored user identifiers and associated access tokens from the database. The server constructs request messages including user identifiers, authentication data, and query parameters, and transmits them to external services via a network protocol. The server receives response messages containing text posts and metadata. As output, the server parses these responses into internal records and stores the text content and associated metadata in a database table of external behavioral data.

### Step 5

The server aggregates the user attribute information and the external behavioral data into a unified data set for subsequent analysis. As input, the server reads profile records and text records associated with a particular user from multiple tables. The server joins these records using the user identifier, aligns timestamps to common time zones, and removes duplicate or inconsistent records. As output, the server produces a consolidated data structure per user, containing profile fields, lists of text entries, and time-based metadata, and keeps this structure in working memory or writes it to an intermediate storage area.

Step 6

The server performs normalization processing on character information contained in the consolidated data structure. As input, the server uses the text entries from Step 5. The server converts character encodings to a unified internal encoding, transforms all letters to a chosen case, replaces or removes special symbols, and normalizes whitespace. The server also standardizes formats for dates, times, and numeric expressions embedded in text. As output, the server generates normalized text sequences that are free from encoding inconsistencies and irregular formatting and stores these sequences in a prepared text field within the working data structure.

Step 7

The server applies a natural language processing program to the normalized text sequences to extract feature terms. As input, the server provides the normalized text associated with each user to the natural language processing module. The server performs tokenization to split text into tokens, removes stop words, and applies lemmatization or stemming to reduce inflected forms to base forms. The server then matches tokens against a domain-specific vocabulary and pattern rules to detect feature terms related to activities, locations, and preferences, such as terms indicating visits to cafes, travel behavior, or preference for quiet environments. As output, the server produces a list of identified feature terms for each user and stores these lists in a dedicated feature-term field.

### Step 8

The server performs aggregation processing of occurrence frequency for the extracted feature terms to generate feature quantity information. As input, the server uses the feature-term lists from Step 7 along with timestamp information. The server counts how many times each feature term appears for the user, computes occurrence frequencies over defined time windows, calculates ratios between categories (for example, cafe-related terms versus travel-related terms), and derives additional statistics such as moving averages and trend indicators.

As output, the server generates feature quantity vectors, each vector containing numerical values indexed by feature type and time segment, and stores these vectors in a feature quantity table or data structure.

### Step 9

The server classifies the user into one or more behavioral pattern categories based on the feature quantity information. As input, the server takes the feature quantity vectors from Step 8. The server applies either a rule-based classifier, which uses predetermined conditions (for example, a threshold on the frequency of a specific feature), or a machine learning classifier, which applies a trained model such as a neural network or a decision-tree-based model. The classifier outputs one or more behavioral pattern labels that describe dominant behavior types, such as “urban cafe explorer” or “weekend traveler.” As output, the server assigns these behavioral pattern categories to the user and records them in a behavioral pattern table linked to the user identifier.

### Step 10

The server constructs a base prompt sentence to be input to the generative AI model using template information and the derived user data. As input, the server uses the feature quantity information, behavioral pattern categories, and static or configurable text templates stored in memory. The server selects an appropriate template based on the behavioral pattern categories, replaces placeholder tokens in the template with concrete data values (for example, city type, activity frequency, and disliked conditions), and composes a coherent description of the user and the intended task. As output, the server generates a base prompt sentence that includes a situation description of the user and general proposal generation conditions.

### Step 11

The server augments the base prompt sentence with output specification information and constraint condition information to create a final prompt sentence for the generative AI model. As input, the server uses the base prompt sentence from Step 10 and configuration parameters defining desired output structure and constraints. The server appends explicit instructions specifying the number of items to generate, fields to include in each item, formatting rules (for example, enumerated lists or clear field labels), and constraints such as location, budget, or time limits. As output, the server produces a fully defined prompt sentence that can be directly used as input to the generative AI model.

### Step 12

The server transmits the final prompt sentence as part of inquiry information to the information processing service providing the generative AI model. As input, the server uses the completed prompt sentence from Step 11, along with parameters for generation such as maximum length and diversity settings. The server wraps the prompt sentence and parameters into a request message, sends the message over the communication network through the communication interface, and waits for a response. As output, the server produces and transmits a network request to the information processing service.

### Step 13

The server receives proposal information generated by the generative AI model in response to the prompt sentence. As input, the server takes the response message returned by the information processing service. The server extracts the text representing the proposal information, verifies that the response conforms to the expected structure indicated by the output specification information, and checks for errors or missing segments. As output, the server obtains a structured or semi-structured representation of the proposal information, such as a list of recommended items with descriptive fields.

### Step 14

The server performs filter processing on the proposal information to enforce system-level and user-level constraints. As input, the server uses the structured proposal data from Step 13 and local constraint data such as geographic boundaries, availability data, and user-specified exclusions. The server iterates over each recommended item, checks attributes such as location and category against constraint rules, and discards or modifies items that do not satisfy the rules. As output, the server produces a filtered set of recommendations that are consistent with both the prompt constraints and additional internal system conditions.

### Step 15

The server executes supplementary information addition processing on the filtered proposal information. As input, the server takes the filtered recommendations from Step 14. The server generates and attaches technical metadata, such as unique identifiers, links to map services, category tags, and localization strings. The server may also compute derived fields, such as estimated distance from the user's typical area or predicted suitability scores. As output, the server generates an enriched recommendation data set ready for user interface rendering and stores it temporarily or persistently in a recommendation table.

### Step 16

The server converts the enriched recommendation data into a display format suitable for the terminal. As input, the server uses the enriched recommendations from Step 15 and capability information for the target terminal, such as screen size and supported interaction modes. The server selects a layout template, orders the recommended items, truncates or reformats text to fit on the display, and structures the data in a format easily parsed by the client-side application. As output, the server produces display-formatted recommendation content associated with the user and sends it through the communication interface to the terminal over the communication network.

### Step 17

The terminal receives the display-formatted recommendation content from the server and renders it to the user. As input, the terminal takes the formatted data message delivered through the communication module. The terminal parses the content, maps fields to user interface components, and draws textual and visual elements on the display. The terminal may present each recommended item with a title, short description, and interactive controls. As output, the terminal presents a graphical view of the recommendations to the user and updates its local state to reflect the displayed content.

### Step 18

The user interacts with the displayed recommendations using the terminal. As input, the user provides touch, click, or keyboard actions on items such as “save,” “dismiss,” or “request similar items.” The terminal captures these interactions, converts them into structured feedback events, and stores them temporarily. As output, the terminal generates feedback messages that encode the user's reactions to each recommendation and prepares these messages for transmission.

### Step 19

The terminal transmits the feedback messages to the server, and the server updates its internal data based on the feedback. As input, the server receives the feedback events generated in Step 18. The server parses each event, associates it with the corresponding recommendation and user identifier, and updates feedback tables in the database by incrementing counters or adding new records. The server may also use these feedback signals to adjust weights or thresholds used in feature aggregation and classification. As output, the server produces updated feature quantity information or updated behavioral pattern data in subsequent processing cycles, thereby refining future prompt sentences and improving subsequent interactions with the generative AI model.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional recommendation systems that operate over network-based commerce platforms typically rely on manually engineered rules or simple statistical models that use limited profile attributes and historical purchase records. Such systems often treat user-generated text, such as posts on communication services and social networks, as unstructured data that is either ignored or reduced to coarse tags. As a result, the systems fail to capture fine-grained, dynamic context such as the user's current season, planned activities, travel situations, or transient preferences expressed in natural language.

Furthermore, although natural language generation models and generative artificial intelligence models have recently become available as external services, conventional systems generally apply these models in a superficial way, for example by directly feeding raw profile data or ad hoc text into the model. In such configurations, the prompt sentences used as input to the generative model are not systematically constructed from structured user signals, recommendation results, and product attributes. This often leads to generated texts that are generic, inconsistent with the actual recommendation logic, or misaligned with the user's real-time context.

From a computer technology standpoint, existing architectures typically do not provide an integrated data processing pipeline that: (i) acquires and normalizes user-generated information from multiple communication service interfaces, (ii) performs natural language processing to derive structured keyword information with explicit categories and weights, (iii) encodes such information as machine-usable feature data for a trained recommendation algorithm, and (iv) uses the same structured information to programmatically construct context-rich prompt sentences for a generative model. The absence of such an integrated pipeline leads to inefficient use of computational resources, duplication of processing across separate subsystems, and difficulty in maintaining consistency between recommendation decisions and generated explanatory texts.

In particular, conventional systems do not effectively utilize user interaction data, such as browsing and purchase operations at user terminals, as feedback to refine both the recommendation model and the construction of prompts for generative models. Feedback is often logged in isolated systems, without being systematically incorporated into training data for the recommendation algorithm, and without being used to adapt the content and structure of prompt sentences. This limits the ability of the computer system to improve its performance over time in a data-driven and automated manner.

Accordingly, there is a need for an improved computer-implemented system that can: (1) acquire and integrate personal information and user-generated text from various network interfaces into a unified internal representation; (2) apply natural language processing techniques to extract keyword information with explicit contextual categories and weights; (3) encode this information into feature data usable by a trained recommendation algorithm executing on a processor; (4) generate, in a systematic and reproducible way, prompt sentences for a generative artificial intelligence model that are conditioned on the same structured data used for recommendation scoring; and (5) capture user interaction behavior as feedback to update the training data of the recommendation algorithm. Such a system should improve the technical performance of the computer-based recommendation pipeline, including improved relevance of recommended items, improved coherence between recommendations and generated explanation texts, more efficient data reuse across components, and enhanced adaptability of the models through automated feedback integration.

The specific processing by the specific processing unit 290 of the data processing device 12 in Application Example 1 is realized by the following means.

The present invention provides a server comprising a processor and a storage device, the processor being configured to execute instructions to acquire personal information and user-generated information of a user, to store in the storage device the user-generated information including input data transmitted from a terminal of the user and post data acquired via an application programming interface of a communication service in association with the personal information, to perform natural language processing on the user-generated information stored in the storage device to extract keyword information from the post data and to structure and store the keyword information as an internal representation in association with user attribute information, to encode the user attribute information and the keyword information as feature data and to execute a trained recommendation algorithm that performs inference processing based on a combination of the feature data and product information so as to generate recommendation candidate information, to acquire via an application programming interface of an external information providing service product information corresponding to the recommendation candidate information and to integrate the product information with the recommendation candidate information, to generate a prompt sentence for input to a generative information processing model on the basis of context information including the user attribute information, the keyword information, and the recommendation candidate information, to input the prompt sentence and the recommendation candidate information to the generative information processing model and to cause the generative information processing model to generate explanation text information corresponding to each recommendation candidate, to generate presentation data including the explanation text information and the product information and to transmit the presentation data to the terminal of the user via a communication network, and to acquire browsing operation information and purchase operation information transmitted from the terminal of the user, to store the browsing operation information and the purchase operation information as behavior history, and to update training data for the trained recommendation algorithm on the basis of the behavior history. This enables an integrated computer-implemented recommendation pipeline in which user-generated natural language content is converted into structured feature data for both recommendation scoring and prompt construction, product information is programmatically combined with recommendation results, generative models produce context-consistent explanatory texts driven by systematically generated prompt sentences, and user interaction feedback is automatically incorporated into the training data, thereby improving the technical performance, accuracy, and adaptability of the server-based recommendation system.

The term “personal information” refers to information that characterizes a user as an individual, including but not limited to demographic attributes, physical attributes, preference attributes, lifestyle attributes, and other profile-related attributes that are explicitly provided by the user or inferred from user behavior.

The term “user-generated information” refers to information created or provided by a user through interaction with a computing system or communication service, including but not limited to text posts, comments, messages, input form data, and other content entered or transmitted by the user.

The term “terminal” refers to an electronic computing device operated by a user, such as a mobile device, a tablet device, a desktop device, or a similar client device, that is capable of communicating with a server over a communication network.

The term “communication service” refers to a network-based service that enables users to generate, publish, or exchange information, including but not limited to social networking services, messaging services, microblogging services, and similar online platforms.

The term “application programming interface” refers to a programmatic interface provided by a service or platform that allows software components to request and exchange data or functionality using defined protocols and data formats.

The term “post data” refers to user-generated text or content items obtained from a communication service via an application programming interface, including but not limited to status updates, posts, messages, and associated metadata.

The term “storage device” refers to a hardware or virtual component capable of persistently storing digital data, including but not limited to magnetic storage, solid-state storage, or network-attached storage, and logical structures such as databases and file systems.

The term “user attribute information” refers to structured data representing characteristics of a user, including personal information, derived attributes, and profile-related parameters, which are usable as input features in data processing and inference.

The term “natural language processing” refers to computational techniques and algorithms that analyze, interpret, or transform human language text data, including but not limited to tokenization, parsing, entity extraction, keyword extraction, sentiment analysis, and text classification.

The term “keyword information” refers to structured data elements derived from natural language text, representing salient terms, entities, or phrases that capture aspects of a user's context, intent, or preferences, optionally associated with categories, weights, or other metadata.

The term “internal representation” refers to a structured, machine-readable format in which processed data such as keyword information and user attribute information are stored and organized for subsequent computational use.

The term “feature data” refers to numerical or categorical representations derived from user attribute information, keyword information, and other inputs, encoded in a form suitable for processing by a machine learning model or recommendation algorithm.

The term “trained recommendation algorithm” refers to a computational model or procedure, obtained through a training process using historical data, that computes relevance scores or selection results for items such as products based on input feature data.

The term “inference processing” refers to execution of a trained recommendation algorithm or model to generate outputs, such as recommendation scores or ranks, from given input feature data without modifying the model parameters.

The term “product information” refers to data describing an item to be recommended, including but not limited to identifiers, names, categories, attributes, images, prices, availability, and associated metadata.

The term “recommendation candidate information” refers to data representing one or more items selected by the trained recommendation algorithm as potential recommendations for a user, including item identifiers, scores, and associated attributes.

The term “external information providing service” refers to a network-accessible service that supplies product information or related data through an application programming interface, such as an online commerce information service or catalog service.

The term “generative information processing model” refers to a computational model, including but not limited to a generative artificial intelligence model, that generates text or other outputs in response to input data such as prompt sentences.

The term “prompt sentence” refers to structured text data provided as input to a generative information processing model, the text data including instructions, context information, and conditions that guide the content and style of generated output.

The term “explanation text information” refers to text generated by the generative information processing model that describes, justifies, or explains recommendation candidates or products in relation to a user's context or preferences.

The term “context information” refers to combined data that characterizes a situation for generating recommendations or explanatory text, including user attribute information, keyword information, recommendation candidate information, and related state data.

The term “presentation data” refers to structured output data prepared for transmission to a terminal, the data including recommendation information, product information, and explanation text information formatted for display to a user.

The term “communication network” refers to a wired or wireless network infrastructure that enables data communication between a server and one or more terminals, including but not limited to the Internet, local area networks, and mobile communication networks.

The term “browsing operation information” refers to data indicating user interactions related to viewing or inspecting recommended items or content on a terminal, including but not limited to clicks, scrolls, selections, dwell times, and navigation events.

The term “purchase operation information” refers to data indicating user actions related to initiating or completing a transaction for an item, including but not limited to add-to-cart events, order confirmations, and payment confirmations.

The term “behavior history” refers to stored records of user interactions, including browsing operation information and purchase operation information, which are associated with a user and used for analysis or model training.

The term “training data” refers to datasets constructed from behavior history, user attribute information, keyword information, product information, or other signals, which are used to train or update a trained recommendation algorithm or model.

In one embodiment, a server cooperates with one or more terminals operated by users to implement a personalized recommendation system that generates explanation texts using a generative AI model based on structured user information. The server is implemented on general-purpose computing hardware such as a rack-mounted server or a virtual machine instance provided by a cloud computing environment. The server includes a central processing unit, a main memory, a non-volatile storage device, and a network interface. The server executes an operating system such as a general-purpose server operating system and a middleware stack including a web application framework, a database management system, and client libraries for external application programming interfaces.

A terminal is implemented as a mobile computing device such as a smartphone or tablet, or as a stationary computing device such as a desktop computer. The terminal includes a processor, a memory, a display device, input devices, and a wireless or wired network interface. The terminal executes a client application, for example a native mobile application or a browser-based application, that communicates with the server via a communication network and provides user interfaces for entering personal information, granting access to communication services, and viewing recommended items.

The user operates the terminal to input personal information such as body characteristics, preferences, lifestyle conditions, and planned events. The terminal presents forms and interactive components implemented, for example, using a mobile user interface toolkit. The terminal acquires contextual information including time and location via operating system APIs for clock and positioning. The terminal formats these data as structured records, such as key-value pairs, and transmits them to the server using a secure HTTP protocol.

The server receives personal information and user-generated information from the terminal and from communication services via application programming interfaces. The server uses a web application framework to parse incoming messages and to authenticate the source. The server stores the received data in a storage device managed by a database management system. The server creates database tables or collections for user profiles, user posts, extracted keywords, recommendation results, and feedback events. The server uses an index structure combining user identifiers, timestamps, and feature identifiers to enable efficient retrieval and update operations.

The server acquires post data from communication services by using available application programming interfaces. The server stores authorization tokens received from the terminal and subsequently uses these tokens to call endpoints of the communication service. The server issues HTTP requests specifying query parameters for language, date range, and content type. The server receives responses encoded in a structured data format and extracts text fields, timestamps, and metadata. The server writes these values into the user posts storage area while normalizing character encoding and recording source identifiers.

The server performs natural language processing on the stored post data to generate keyword information. The server executes a text normalization component that performs lowercasing where applicable, removal of URLs, and replacement of special characters. The server applies a tokenizer suitable for the language of the post, and then passes the tokenized text to a named entity recognition module and a keyword extraction module. In one embodiment, the server calls an external natural language processing service through a remote procedure call interface and receives, for each sentence or document, a list of entities and associated salience scores.

The server converts the raw results of natural language processing into structured keyword records. The server associates each term or entity with a category label such as season, activity, location, product-type, or preference. The server assigns a weight value to each keyword by combining the salience score received from the natural language processing service, the recency of the post, and user-specific factors such as historical interest. The server stores each keyword record in an internal representation that includes a user identifier, a keyword string, a category identifier, a weight value, and a source identifier. This internal representation is optimized for reuse so that subsequent processing steps can access structured context information without reprocessing the original text.

The server generates feature data suitable for machine learning-based recommendation by encoding user attribute information and keyword information into numerical vectors. The server converts categorical attributes such as style preferences or climate categories into one-hot encoded vectors. The server normalizes numerical attributes such as age, body measurements, or budget values using scaling methods. The server generates keyword embeddings by mapping keyword strings to dense vectors using a pre-trained word embedding model, such as a neural network that has been trained on large text corpora. The server aggregates keyword embeddings for each category by weighted averaging based on the weight values assigned during keyword extraction.

The server concatenates profile feature vectors and keyword feature vectors to create a unified user feature vector. The server constructs product feature vectors from product information stored in one or more product catalogs. Product information includes category identifiers, material codes, season labels, price ranges, and other attributes that are encoded into numerical vectors through similar encoding and normalization processes. The server writes these user and product feature vectors into in-memory data structures to be used by a trained recommendation algorithm.

The server executes a trained recommendation algorithm that computes relevance scores for combinations of user feature vectors and product feature vectors. In one embodiment, the server uses a neural network-based model having an architecture composed of a user tower and an item tower. Each tower comprises multiple fully connected layers with nonlinear activation functions. The server feeds the user feature vector into the user tower and the product feature vector into the item tower, and obtains latent representations for the user and the product. The server then computes a similarity score, for example a dot product or cosine similarity, and interprets this as a relevance score.

The server trains the neural network-based recommendation model offline using historical interaction data stored as training data. The server initializes the model weights using random values and iteratively updates them by minimizing a loss function, such as a cross-entropy loss or a pairwise ranking loss, computed over batches of historical user-item interactions. The server uses an optimization algorithm such as stochastic gradient descent with momentum or adaptive gradient methods. The server uses regularization techniques such as dropout or weight decay to avoid overfitting. The server periodically retrains the model using updated behavior history that includes new browsing operation information and purchase operation information received from terminals.

The server chooses a set of recommendation candidate information by evaluating the trained model over a filtered set of product feature vectors. The server applies pre-filtering conditions using database queries to select only products that satisfy basic constraints such as category, season, availability, and size compatibility. The server then computes relevance scores for the remaining items using the trained model. The server sorts the items by score and selects the top results as recommendation candidates. The server stores for each candidate an identifier, the relevance score, and selected attributes.

The server acquires product information for the recommendation candidates from an external information providing service via an application programming interface. The server issues requests specifying product identifiers and retrieves product titles, images, detailed attributes, and purchase links. The server merges this returned product information with the recommendation candidate information and stores the merged records as product recommendation entries in the storage device.

The server generates a prompt sentence for a generative AI model based on context information including user attribute information, keyword information, and recommendation candidate information. The server constructs the prompt sentence using a rule-based template system that determines the order and selection of content fields. The server includes in the prompt a textual summary of the user profile, a list of extracted keywords with associated categories, and a description of each candidate product including key attributes such as material, warmth level, water resistance, and price range. The server also adds explicit instruction text that specifies the required style, length, and content constraints of the output. For example, the server may generate a prompt sentence as follows:

“The user has posted: ‘I'm looking for the perfect jacket for an autumn trip.’ The user profile is: body type=medium, preferred style=casual, living environment=cool climate, budget=mid-range. The following products are candidates:
1) Product A: lightweight, water-repellent, medium warmth, price=$90.
2) Product B: heavy down, very warm, not water-repellent, price=$150.
3) Product C: soft shell, water-resistant, medium warmth, price=$120.

Analyze the user's needs and write one concise English sentence for each product explaining why it is suitable or not ideal for an autumn trip. Then recommend the best one at the end.” In another example, the server may generate a prompt sentence as follows:

“Given the user profile (body type: medium, style: casual, climate: cool, budget: mid-range) and the keywords [‘autumn’, ‘travel’, ‘jacket’], write three short recommendation sentences for the following products with attributes as described. Focus on clarity and relevance to an autumn trip.”

The server transmits the prompt sentence and structured candidate information to the generative AI model through an application programming interface provided by a text generation service. The server specifies parameters such as maximum output length, temperature, and top-k sampling to control the variability and determinism of the generated explanation text. The server receives the generated explanation text and associates each segment of text with the corresponding recommendation candidate by parsing the response according to predefined markers or positions.

The server generates presentation data for the terminal by combining the explanation text information with the product information. The server formats this data as a structured response containing for each recommended item: the product title, image URL, price information, purchase URL, and the generated explanation text. The server transmits this presentation data to the terminal over the communication network.

The terminal receives the presentation data and renders user interfaces that display the recommended items. The terminal uses a layout manager and an image loading component to display product images and texts efficiently. The terminal arranges the items in a list or grid and displays the explanation text near each product, enabling the user to understand why a particular product is recommended based on the user's context. The terminal handles user interactions such as selection of items, scrolling, and activation of purchase links.

The user views the recommended items on the terminal and may select a product to view details or initiate a purchase. When the user interacts with recommended items, the terminal records browsing operation information such as item identifiers, timestamps, and interaction types. The terminal also records purchase operation information when the user completes a transaction on an associated commerce platform. The terminal sends these interaction records to the server at predetermined intervals or upon occurrence of specific events.

The server stores browsing operation information and purchase operation information as behavior history in the storage device. The server aggregates and indexes this behavior history for use in updating training data. The server periodically constructs data batches for model training, where each batch includes feature vectors corresponding to historical user states and labels derived from interaction outcomes such as click-through or purchase. The server increments the training dataset with new entries and retrains the recommendation model accordingly, which results in improved relevance of the recommendation candidate information.

From a technical perspective, the described configuration improves computer technology in several ways. The server reuses a unified internal representation of keyword information and user attribute information both for recommendation scoring and for prompt generation, thereby reducing redundant computations and memory usage. The server's use of category-specific keyword weighting and embedding aggregation enables the neural network to receive more informative feature vectors, which improves the accuracy of inference and reduces the number of model evaluations needed to achieve a given level of relevance. The explicit template-based construction of prompt sentences from structured data ensures that the generative AI model operates on consistent, machine-structured context rather than arbitrary or unstructured text, which leads to more predictable and coherent outputs. The server's integration of behavior history into the training loop allows automated adaptation of model parameters in response to changing user preferences, improving long-term performance without manual rule updates. By controlling model architecture, feature encoding, optimization algorithm, and loss function, the server implements a non-conventional data processing pipeline that differs from simple rule-based or manually tuned systems. As a result, processing speed is improved because fewer candidate items need to be presented to the generative AI model, and communication load is reduced because the server transmits compact structured representations instead of raw post collections or complete catalogs.

The server, terminal, and user together implement the described system. The server performs data acquisition, natural language processing, feature generation, recommendation, prompt construction, generative text processing, and feedback-based training using specific hardware and software components. The terminal provides input and display functions, manages network communication, and captures user interactions. The user provides personal information and operational inputs that drive the system. The described embodiments are illustrative, and alternative implementations may vary the architecture of the recommendation model, the choice of natural language processing techniques, the structure of feature vectors, or the prompt construction rules, while remaining within the scope defined by the claims.

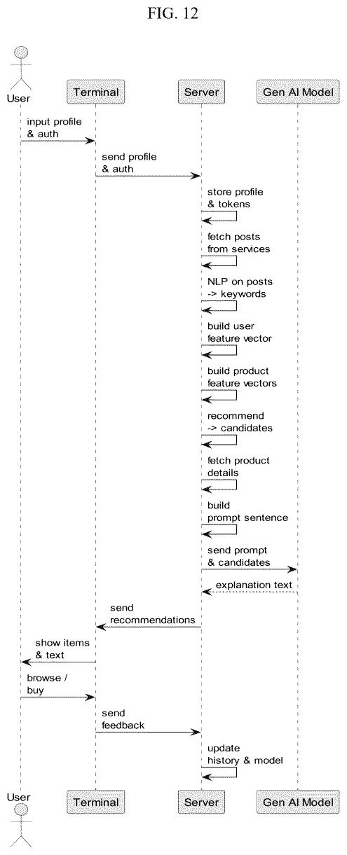

The following describes the processing flow using FIG. 12.

### Step 1

The user operates the terminal to input personal information and to grant access to communication services. The terminal displays input forms and selection screens that allow the user to enter body characteristics, style preferences, lifestyle conditions, budget ranges, and planned events, and to press buttons such as “Connect social service.” The input of this step is touch and keyboard events generated by the user and access approval operations for external communication services. The terminal processes these inputs by mapping them into structured values, performing basic validation such as checking required fields and value ranges, and constructing internal data objects representing the personal information and authorization tokens. The output of this step is a set of structured user profile records and communication service authorization data stored in the terminal's memory.

### Step 2

The terminal transmits the user profile records and the communication service authorization data to the server. The input of this step is the structured data generated in Step 1. The terminal serializes the profile records into a request message, attaches authorization headers or tokens, and sends the message over a communication network using a secure transport protocol. The terminal may compress the body of the message to reduce communication load. The output of this step is a network request that the server receives as a data packet containing encoded personal information and authorization information.

### Step 3

The server receives the request containing personal information and authorization data from the terminal and stores the data in a storage device. The input of this step is the network request generated in Step 2. The server decodes the message, verifies integrity and authentication, and parses the payload into internal data structures. The server performs data validation such as type checking, range checking, and schema conformance. The server then writes the validated user profile information into a user profile table and writes the authorization tokens into a secure credential store, associating each entry with a user identifier and timestamps. The output of this step is a set of persistent user profile records and authorization records stored in the storage device.

### Step 4

The server acquires user-generated post data from one or more communication services by using the stored authorization records. The input of this step is the authorization records and user identifiers stored in Step 3. The server constructs application programming interface requests including access tokens, user identifiers, and query parameters such as date range, language, and maximum number of posts. The server sends these requests to endpoints of the communication services and receives responses containing collections of posts with text, metadata, and timestamps. The server parses the responses, extracts the text content and relevant metadata, and normalizes character encodings. The output of this step is a set of stored post records linked to user identifiers in a user posts table or collection.

### Step 5

The server preprocesses the text of the post records and executes natural language processing to extract keyword information. The input of this step is the post records stored in Step 4. The server reads the text fields, removes URLs, special characters, and excessive whitespace, and applies tokenization appropriate to the language of each post. The server may call an external natural language processing service, sending the normalized text as input, and receive entities and salience scores as output, or execute an internal keyword extraction module. The server then constructs keyword candidates by grouping related tokens and entities, and calculates weight values by combining salience scores, recency factors, and frequency counts. The output of this step is a set of keyword records that include keyword strings, category labels, and weight values associated with user identifiers.

### Step 6

The server converts user profile information and keyword records into feature data suitable for use by a recommendation model. The input of this step is the user profile records from Step 3 and the keyword records from Step 5. The server encodes categorical attributes using one-hot or multi-hot encoding, normalizes numerical values using scaling functions, and maps keyword strings to dense vectors using a pre-trained embedding model. The server aggregates keyword embeddings for each category by computing weighted averages based on the corresponding weight values. The server concatenates the encoded profile features and aggregated keyword embeddings to form a user feature vector for each user. The output of this step is a set of user feature vectors stored in memory or in a feature store.

### Step 7

The server retrieves product information and constructs product feature vectors. The input of this step is a product catalog stored locally or accessible via an external information service. The server queries the catalog using filters such as category, availability, and season, and optionally calls an external product information application programming interface to obtain additional attributes such as material type, warmth level, water resistance, and price. The server encodes these attributes into numerical and categorical features using encoding schemes similar to those used for user features. The server assembles the encoded values into product feature vectors and stores them in a product feature repository. The output of this step is a set of product feature vectors associated with product identifiers.

### Step 8

The server applies a trained recommendation algorithm to compute relevance scores between user feature vectors and product feature vectors and to generate recommendation candidate information. The input of this step is the user feature vectors from Step 6 and the product feature vectors from Step 7. The server loads model parameters of a trained neural network that includes a user tower and a product tower, feeds each user feature vector into the user tower and each product feature vector into the product tower, and obtains latent representations. The server computes a similarity metric such as a dot product between the user and product latent vectors, resulting in a relevance score for each pair. The server sorts products by relevance score for each user and selects the top-ranked products as recommendation candidates. The output of this step is recommendation candidate information including product identifiers and associated relevance scores.

### Step 9

The server enriches the recommendation candidate information with detailed product information retrieved from an external information providing service. The input of this step is the recommendation candidate information from Step 8. The server constructs a list of product identifiers, sends application programming interface requests to the external service specifying these identifiers, and receives structured product details such as images, descriptions, and updated prices. The server merges the retrieved product details into the recommendation candidate records and updates the storage so that each candidate includes both scoring results and display attributes. The output of this step is a refined set of recommendation candidate entries containing identifiers, attributes, and scores.

### Step 10

The server constructs a prompt sentence for a generative AI model using context information derived from user attributes, keyword information, and recommendation candidate entries. The input of this step is the user profile records and keyword records from Steps 3 and 5, together with the refined recommendation candidate entries from Step 9. The server selects a subset of profile fields and keyword strings that best describe the current context and selects key attributes from each candidate product, such as material, usage scenario, and price band. The server inserts these values into a pre-defined textual template that specifies the order and structure of the prompt, and adds explicit instruction text describing required style, length, and focus of the output. The output of this step is a context-rich prompt sentence in natural language and a mapping of product identifiers to positions in the prompt.

### Step 11

The server transmits the prompt sentence and associated candidate data to a generative AI model and obtains explanation text for each recommendation candidate. The input of this step is the prompt sentence from Step 10 and structured candidate data. The server sends a request to a generative model service application programming interface with parameters such as maximum token count, temperature, and nucleus sampling threshold. The generative AI model returns a generated text that follows the instructions contained in the prompt sentence. The server parses the returned text according to predefined delimiters or formatting rules to associate each segment of explanation text with the corresponding candidate product. The output of this step is a set of explanation text segments linked to recommendation candidates.

### Step 12

The server integrates the explanation text segments and the product details into presentation data and sends this data to the terminal. The input of this step is the enriched candidate entries from Step 9 and the explanation text segments from Step 11. The server constructs a response object that, for each candidate, includes the product title, image reference, price, purchase URL, and associated explanation text. The server may also include layout hints, such as display order and grouping. The server serializes this response into a message format and sends it to the terminal via the communication network. The output of this step is a presentation message that the terminal receives and can render for the user.

### Step 13

The terminal receives the presentation data and displays the recommended items and explanation texts to the user. The input of this step is the presentation message from Step 12. The terminal parses the structured data, loads images from the specified URLs, and creates visual components such as list items, images, and text labels. The terminal lays out the components on the display, rendering the explanation text near each product so that the user can easily understand the rationale behind the recommendation. The terminal may apply local caching and asynchronous image loading to improve responsiveness. The output of this step is a rendered user interface that shows recommended products and their explanations on the terminal display.

### Step 14

The user views the recommended items on the terminal and performs browsing and purchase operations. The input of this step is the displayed user interface from Step 13. The user scrolls through the list, taps items to view details, and activates purchase links. These interactions generate user interface events and navigation events within the terminal. The output of this step is raw interaction data such as item identifiers clicked, times spent on detail views, and purchase initiation events, all captured within the terminal.

### Step 15

The terminal records the browsing and purchase interactions and sends feedback data to the server. The input of this step is the raw interaction data generated in Step 14. The terminal aggregates events over a session, converts them into structured records including user identifiers, item identifiers, timestamps, and event types, and may compress or batch them to reduce communication overhead. The terminal then transmits the feedback records to the server via a designated feedback endpoint. The output of this step is a feedback message containing structured behavior data received by the server.

### Step 16:

The server receives the feedback message and updates behavior history and training data for the recommendation algorithm. The input of this step is the feedback message from Step 15. The server parses the message, validates the structure and identifiers, and writes each event into a behavior history store with appropriate indexing. The server then generates or updates training examples by pairing user feature vectors and product feature vectors with labels derived from the interaction types, such as positive labels for purchases and negative labels for ignored items. The server appends these examples to a training dataset and, in scheduled training sessions, uses them to adjust the parameters of the recommendation model using gradient-based optimization. The output of this step is an updated behavior history and an updated set of model parameters that improve future relevance scoring and, indirectly, the quality of subsequent prompt sentences and generated explanations.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional outfit recommendation systems generally rely on static rule sets or simple scoring algorithms that treat user attributes, contextual information, and purchase behavior as loosely connected data. As a result, such systems often fail to generate context-aware and user-tailored proposals with sufficient precision or explanatory detail. In particular, known systems typically (i) do not perform systematic preprocessing and feature generation optimized for machine learning, (ii) do not continuously update an inference model based on actual user selections, and (iii) do not integrate a generative AI model in a manner that exploits machine-learned estimation results as structured inputs to generate high-quality natural-language guidance.

From a computer-technology perspective, existing architectures do not provide an efficient pipeline that transforms heterogeneous user-related data and environment-related data into feature data suitable for machine learning, applies an adaptive inference model to compute candidate items, and then uses the inference output as a control signal for a generative AI model. This lack of integration leads to increased processing redundancy, poor reuse of behavioral data, and weak coupling between recommendation logic and natural-language output logic. Consequently, computing resources are not effectively utilized, and the overall responsiveness and usefulness of the recommendation service are degraded.

Furthermore, in typical systems, prompt sentences for generative AI models are handcrafted or generated using fixed templates that are not systematically linked to the internal state of the recommendation engine. This causes an inconsistency between the underlying recommendation calculation and the natural-language explanation presented to the user. It also complicates maintenance and scaling, because changes to the recommendation logic must be manually reflected in the prompt design. Thus, there is a need for a computer-implemented technique that automatically constructs prompt sentences based on structured feature data, estimation results, and contextual information, thereby improving the coherence and reliability of the generated natural-language proposals.

There is therefore a demand for an improved data processing architecture that: (1) acquires and stores user attribute and behavior information as reusable personal information; (2) performs explicit preprocessing and feature generation optimized for machine learning; (3) trains and updates an inference model using past selection history; (4) computes candidate outfits in a context-aware manner; (5) automatically generates prompt sentences for a generative AI model based on the inference result and context information; and (6) feeds back actual user selections as training data. Such an architecture is expected to improve the technical performance of the overall computer system, including accuracy and stability of recommendations, efficiency of model training and inference, and consistency between numerical estimation and natural-language output.

The specific processing by the specific processing unit 290 of the data processing device 12 in Example 2 is realized by the following means.

The present invention provides a server comprising a processor and a memory storing instructions which, when executed by the processor, cause the processor to acquire attribute information and behavior information from a user via a terminal device and store the attribute information and the behavior information as personal information in an information management apparatus; read a plurality of types of information including the personal information and environment information from the information management apparatus and generate feature data by performing data preprocessing including normalization of numerical information and encoding of categorical information; select an inference model for performing learning processing based on the feature data and past selection history information, update the inference model to calculate clothing candidates as an estimation result, and record the estimation result in association with the personal information; generate a prompt sentence for input to a generative artificial intelligence model from the estimation result and context information including the environment information, input the prompt sentence to the generative artificial intelligence model to cause the generative artificial intelligence model to generate proposal information in natural language, and validate and store the proposal information; transmit the clothing candidates and the proposal information together with purchase route information to the terminal device via a communication network and control presentation of the clothing candidates and the proposal information to the user; and acquire a selection result of at least one of the clothing candidates from the user, record the selection result as the selection history information in the information management apparatus, and reuse the selection history information in the learning processing of the inference model. This enables a tightly integrated, computer-implemented recommendation pipeline in which heterogeneous user-related and context-related data are transformed into machine-learning-optimized feature data, used to train and update an inference model for estimating clothing candidates, and further exploited to automatically construct and supply prompt sentences to a generative AI model, thereby improving recommendation accuracy, computational efficiency, and consistency between numerical inference and natural-language guidance within the server-based system.

The term “attribute information” refers to information representing inherent characteristics of a user, including but not limited to body-related characteristics, preference-related characteristics, and lifestyle-related characteristics.

The term “behavior information” refers to information representing actions or choices of a user, including but not limited to selection operations, purchase operations, browsing history, and interaction history with a recommendation service.

The term “personal information” refers to information stored in association with a user and including at least attribute information and behavior information, and optionally including profile information, history information, and other user-related information managed by an information management apparatus.

The term “environment information” refers to information representing external conditions surrounding a user, including but not limited to season information, position information, time information, and event information, as well as weather information and social context information.

The term “information management apparatus” refers to a data storage and management system implemented by at least one computing device and configured to store, retrieve, and manage personal information, environment information, selection history information, and other data used by an inference model.

The term “data preprocessing” refers to processing applied to raw data prior to machine learning, including but not limited to cleaning, normalization of numerical information, encoding of categorical information, aggregation, and transformation into feature data.

The term “feature data” refers to data obtained by processing raw data through data preprocessing, the feature data being represented in a form suitable for input to a machine learning model, such as numerical vectors or tensors.

The term “normalization of numerical information” refers to a transformation applied to numerical values so that the numerical values are scaled or standardized into a predetermined numerical range or distribution for stable operation of a machine learning model.

The term “encoding of categorical information” refers to a transformation by which categorical data is converted into numerical representations, including but not limited to one-hot encoding, index encoding, or embedding representations, for use as input to a machine learning model.

The term “inference model” refers to a computational model, such as a machine learning model or statistical model, which is trained using feature data and selection history information and is configured to output an estimation result representing one or more candidates in response to input data.

The term “learning processing” refers to processing by which parameters of an inference model are adjusted based on input feature data and target data, such as selection history information, so as to improve estimation performance of the inference model.

The term “selection history information” refers to information representing past selections or choices made by a user from candidates presented by a system, including but not limited to selected items, non-selected items, timestamps, and contextual conditions at the time of selection.

The term “estimation result” refers to output information generated by an inference model, the output information indicating one or more predicted candidates, such as clothing candidates, and optionally indicating scores, rankings, or other evaluation values associated with the candidates.

The term “clothing candidate” refers to an item or a set of items belonging to an apparel category that is proposed to a user as a candidate for wearing, and which is determined based on an estimation result of an inference model.

The term “context information” refers to information representing a situation in which a recommendation is requested or presented, including but not limited to environment information, user schedule information, event information, and system state information.

The term “generative artificial intelligence model” refers to a computational model configured to generate output data, such as natural-language text, by probabilistically modeling patterns in training data, and which produces content in response to an input such as a prompt sentence.

The term “prompt sentence” refers to a text sequence or structured textual input that is provided to a generative artificial intelligence model in order to instruct the generative artificial intelligence model regarding generation conditions, such as content, tone, style, and length of output.

The term “proposal information” refers to natural-language information generated by a generative artificial intelligence model based on a prompt sentence, the proposal information including at least an explanation or recommendation concerning one or more clothing candidates.

The term “purchase route information” refers to information indicating a pathway by which a user can purchase or obtain a clothing candidate, including but not limited to electronic transaction route information for online purchasing and physical store guidance route information for offline purchasing.

The term “electronic transaction route” refers to an online purchasing pathway represented by information such as a network resource locator, transaction interface specification, or electronic cart identifier enabling completion of a purchase through an electronic commerce system.

The term “physical store guidance route” refers to an offline purchasing pathway represented by information such as a store location, address, map data, or transportation guidance enabling a user to visit a physical retail facility to obtain a product.

The term “terminal device” refers to an end-user computing apparatus, such as a mobile communication device, a portable information processing device, or a stationary information processing device, configured to transmit information to and receive information from a server via a communication network.

The term “communication network” refers to a wired or wireless data communication infrastructure, including but not limited to the Internet, cellular networks, local area networks, or combinations thereof, that enables data exchange between a server and one or more terminal devices.

In one embodiment, a server, a terminal, and a communication network cooperate to implement the claimed system. The server includes at least one processor, a main memory, a non-volatile storage device, and a network interface. The server executes an operating system, middleware, and application software including a data preprocessing module, a machine learning module, and a generative AI integration module. The terminal includes a processor, a memory, a display, an input interface, and a wireless communication module, and executes an application that communicates with the server and provides user interaction. The server uses a relational data storage system as an information management apparatus. The server stores personal information, environment information, feature data, selection history information, and product catalog information in one or more logical tables. For example, the server stores user attribute information such as height, weight, body shape category, preferred colors, preferred fit, and style categories in a user profile table. The server stores behavior information such as selected outfits, purchased items, timestamps, and context conditions at the time of selection in a selection history table. The server stores environment information such as season, geographic coordinates, time, weather, and event types in a context table.

The terminal presents, on a display, input screens that allow the user to enter attribute information and to give consent for behavior tracking. The terminal records user inputs such as body measurements, preferred style, frequency of formal events, and sensitivity to temperature. The terminal transmits the attribute information and behavior information to the server via the communication network using an encrypted communication protocol.

The server receives the attribute information and behavior information and registers the information as personal information in the information management apparatus. The server associates the personal information with a unique user identifier stored in the user profile table. The server also periodically acquires environment information from an external environment information provider via the network interface and stores the environment information in the context table.

The server reads, from the information management apparatus, the personal information and the environment information and generates feature data. The server executes a data preprocessing module implemented using general-purpose numerical computation software and data analysis software. The server applies data normalization to numerical information such as height, weight, temperature, and price. For example, the server converts each numerical field into a standardized value by subtracting a mean and dividing by a standard deviation precomputed for a training population. The server applies encoding of categorical information such as style categories, event types, and weather conditions. For example, the server transforms categorical values into sparse binary vectors via one-hot encoding, or into integer indices that are mapped to dense embedding vectors during model training.

The server constructs feature vectors that combine user attribute features, environment features, and item features. The server defines a data structure in which each feature vector includes a user feature segment, a context feature segment, and an item feature segment. The server stores these feature vectors as feature data in a feature table or in serialized binary files accessible to the machine learning module. By unifying heterogeneous data into a fixed-length numerical representation, the server reduces memory fragmentation and cache misses during model training and inference, thereby improving processing speed and computational efficiency.

The server selects an inference model for estimating clothing candidates. In one embodiment, the server implements the inference model as a feed-forward neural network. The server defines an input layer whose dimension matches the length of the feature vectors, one or more hidden layers with non-linear activation functions, and an output layer that outputs a scalar score or a probability value representing a degree of suitability of a clothing candidate for a given user and context. The server sets the number of hidden layers, the number of neurons, the activation functions, and regularization parameters based on desired accuracy and computational constraints.

The server performs learning processing of the inference model. The server uses the feature data as input and selection history information as target data. For each training example, the server constructs positive pairs in which the clothing candidate was selected by the user under a recorded context, and negative pairs in which the clothing candidate was not selected or was randomly sampled from non-chosen items. The server computes, for each batch of training examples, a loss value such as a cross-entropy loss or a pairwise ranking loss. The server updates weight parameters of the neural network by applying a gradient-based optimization algorithm such as stochastic gradient descent or a variant thereof. The server repeatedly executes forward propagation and backward propagation on batches of feature data, thereby adjusting the parameters to minimize the loss over the training set.

The server monitors training metrics such as training loss, validation loss, top-k hit rate, and mean reciprocal rank. The server adapts learning rates, batch sizes, and regularization coefficients in response to convergence behavior. In some embodiments, the server uses early stopping when validation loss does not improve, thereby preventing overfitting and reducing unnecessary computation cycles. The server periodically stores snapshots of the trained model in the non-volatile storage device, together with metadata describing the training data version and hyperparameters. This explicit model management enables rollback and controlled deployment of updated models.

The server uses the trained inference model to calculate clothing candidates. The server retrieves, from the information management apparatus, the current personal information and environment information associated with a user request. The server constructs feature vectors for each candidate item or item combination in a product catalog. For example, the server combines user feature vectors with context feature vectors and item feature vectors representing material, color, size, silhouette, and functional attributes such as water resistance or thermal insulation. The server provides these feature vectors as input to the inference model to compute estimated suitability scores. The server ranks the item combinations based on the scores and selects the highest-scoring combinations as clothing candidates.

The server then generates a prompt sentence for a generative AI model. The server uses a generative AI integration module that translates the estimation result and context information into structured prompt text. The server constructs a textual description that includes a concise summary of the user profile (e.g., body build and style preferences), the current environment conditions (e.g., temperature, precipitation, time of day, and event description), and the selected clothing candidates with their key attributes. The server appends instruction phrases indicating desired output style, tone, length, and language.

In one example, the server constructs a prompt sentence such as:

“You are a professional fashion stylist using a generative AI model. The user profile: male, 178 cm, average build, prefers minimal and monochrome outfits. The event is a casual dinner with friends. The location is an urban area, and the weather tomorrow evening is light rain with 15° C. The recommended outfit from our ML model is: black waterproof hooded jacket, grey crew-neck sweater, slim-fit dark jeans, and black leather sneakers. Please generate a friendly and concise recommendation message in English (under 150 words) that explains why this outfit suits the user's style, body type, and the rainy weather, and mention that all items are available for quick online purchase via the provided links.”

In another example, the server constructs a prompt sentence such as:

“You are an AI stylist helping a user choose an outfit. The user likes streetwear and oversized silhouettes, and has previously bought hoodies and sneakers from our store. Tomorrow's weather is sunny, high 25° C., in a metropolitan area. The ML model has selected: oversized graphic T-shirt, light denim shorts, and white low-top sneakers. Write a short recommendation message in English (under 120 words) that highlights comfort and style for a weekend outing, and briefly mentions that the items are available for quick online purchase via the included links.”

The server supplies the prompt sentence to a generative AI model. In one embodiment, the generative AI model is a neural network implementing a transformer architecture with multiple self-attention layers, feed-forward layers, and layer normalization components. The server uses a generative model previously trained on large-scale text corpora and optionally fine-tuned on domain-specific fashion recommendation texts. The server transmits the prompt sentence as a sequence of tokens to the generative AI model and receives, in response, a sequence of output tokens representing natural-language proposal information. The server validates the generated proposal information by checking length constraints, presence of required elements (e.g., mention of weather, body type, and style preferences), and absence of prohibited content. The server may apply post-processing to correct formatting or to replace internal identifiers with user-friendly names. The server stores the proposal information in association with the corresponding estimation result and user identifier, which allows later analysis of which generated messages lead to higher selection rates.

The terminal receives, from the server, the clothing candidates, the proposal information, and purchase route information. The terminal displays on the screen a list of outfit sets, each including image data, item descriptions, prices, and the generated natural-language explanation. The terminal renders interactive elements such as buttons or links corresponding to electronic transaction routes and physical store guidance routes. The user reads the explanation and performs selection operations on the terminal.

The server acquires, from the terminal, the selection result of at least one of the clothing candidates. The server records the selection result as selection history information in the information management apparatus, including identifiers of selected items, non-selected candidates, associated prompt sentences, and environmental conditions at the time of selection. The server periodically incorporates this new selection history information into subsequent learning processing of the inference model. In this way, the server realizes a closed-loop learning architecture that continuously adjusts to actual user behavior.

By structuring data in the form of feature vectors and by coupling the inference model output to the generative AI model through dynamically constructed prompt sentences, the server improves the technical performance of the overall computer system. The normalization and encoding of data allow the server to process large numbers of users and items with reduced memory footprint and more efficient use of vectorized operations. The learning-based inference model adapts to complex, non-linear relations between user preferences, environmental conditions, and clothing attributes, thereby providing higher recommendation accuracy than static rule-based systems.

Moreover, the explicit generation of prompt sentences from estimation results and context information reduces redundancy and inconsistency between numerical computation and text generation. Because the server derives prompts directly from internal feature and score data, any updates to the inference model automatically affect the behavior of the generative AI model without manual redesign of templates. This tight integration reduces maintenance overhead and improves scalability. The reduction of manual template engineering and the alignment of numerical estimation with natural-language explanation also reduce the number of network calls and re-computation cycles required to produce coherent recommendations, thereby decreasing communication load and improving response time.

The system exploits capabilities that are not available in conventional human-only workflows. A human stylist cannot, in real time, scan a large product catalog, compute similarity scores between multi-dimensional feature vectors, and construct prompt sentences that carry structured model outputs to a generative model. The server uses non-intuitive combinations of feature engineering, neural network inference, and prompt generation to achieve improved precision and speed, which goes beyond mere automation of human judgment.

In some embodiments, the server implements alternative inference models. The server may use a recurrent neural network or a transformer-based ranking model to capture temporal patterns in selection history information. The server may also employ a matrix factorization model or a graph-based model to exploit relationships between users and items. Different loss functions, such as Bayesian personalized ranking loss or hinge loss, may be used depending on available labels and target metrics. In each case, the server retains the process of generating feature data and translating estimation results into prompt sentences for the generative AI model.

In other embodiments, the server adjusts model structures and parameters to optimize for specific hardware. For example, the server may deploy a compressed version of the inference model using weight quantization or pruning to reduce model size and latency on a particular processor or accelerator. The server may also schedule training operations during periods of low network traffic, thereby reducing contention for resources and improving overall system throughput.

The server may also manage data partitioning and caching strategies to reduce communication overhead. The server may cache frequently accessed user feature vectors and environment patterns in a memory-resident cache. When the terminal repeatedly requests recommendations for similar conditions, the server reuses cached feature data, regenerates prompt sentences with minimal computation, and thereby reduces both processing time and storage access.

Through these embodiments, the server, the terminal, and the associated data structures cooperate to realize an implementation in which heterogeneous data is systematically transformed, modeled, and rendered into coherent natural-language recommendations. This implementation improves computational efficiency, recommendation accuracy, and consistency of outputs, and provides a technical solution that goes beyond general data acquisition and display by specifically configuring the processor to execute integrated machine learning, feature transformation, and generative AI prompt control procedures.

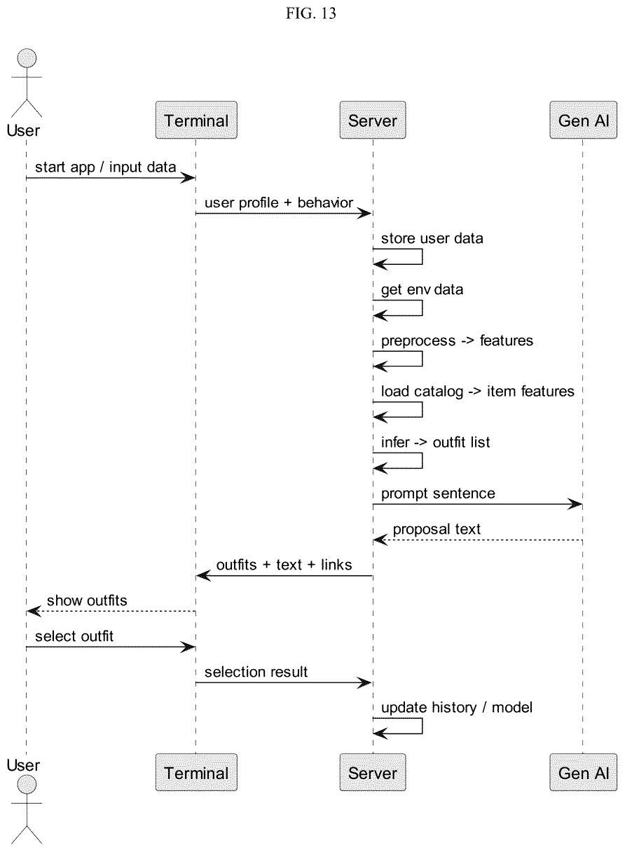

The following describes the processing flow using FIG. 13.

### Step 1

The user operates the terminal to start an application and input personal attribute information. The terminal displays input fields for height, weight, body shape, preferred styles, color preferences, and typical usage scenes.

The input of this step is raw user-entered text and numeric values.

The terminal validates the values (for example, checks that height and weight are within a plausible range and that required fields are filled) and converts the values into a structured data object.

The output of this step is a structured user profile object that the terminal prepares to transmit to the server.

### Step 2

The terminal acquires behavior information from the user, such as past selections, purchase history, and browsing patterns within the application.

The input of this step is the user's interaction events (for example, taps on items, scroll depth, time spent on each outfit).

The terminal aggregates these events into behavior records, each record including item identifiers, timestamps, and context tags.

The output of this step is a behavior information object that the terminal transmits together with the user profile object to the server via a communication network.

### Step 3

The server receives the user profile object and the behavior information object from the terminal through a network interface.

The input of this step is the structured data sent by the terminal.

The server parses the received data, assigns or confirms a unique user identifier, and writes the attribute information and behavior information as personal information into an information management apparatus, such as a relational data storage system.

The server divides the data into multiple logical tables (for example, profile table, behavior table) and stores each field in a predefined column.

The output of this step is persistent personal information stored in the information management apparatus and indexed by the user identifier.

### Step 4

The server acquires environment information relevant to the user, including time, location, season, and optionally weather and event information.

The input of this step is location data from the terminal, current time from a system clock, and environment data from external information providers.

The server normalizes geographic coordinates to region identifiers, maps timestamps to time-of-day categories, and classifies weather conditions into categorical labels such as “rainy,” “sunny,” or “cold.”

The server stores the environment information in a context table linked to the user identifier.

The output of this step is structured environment information associated with the user in the information management apparatus.

### Step 5

The server reads, from the information management apparatus, the personal information and the environment information associated with the user.

The input of this step is a set of database records containing user attributes, behavior history, and current context.

The server performs data preprocessing by cleaning inconsistent values, filling or discarding missing values, and converting raw categorical data into encoded numerical representations using predetermined encoding rules.

The server applies normalization to numerical fields such as height, weight, and temperature, for example by subtracting a mean and dividing by a standard deviation, and applies one-hot encoding or index encoding to categorical fields such as style preference and event type.

The output of this step is a set of feature vectors stored as feature data, each vector combining user features and context features in a unified numerical format.

### Step 6

The server acquires product catalog information representing clothing items from the information management apparatus or an external inventory system.

The input of this step is item records containing attributes such as category, material, color, size, silhouette, and functional properties.

The server encodes item attributes into numerical item feature vectors using the same normalization and encoding rules as those used for user and context features.

The server stores the item feature vectors in an item feature table or feature file, aligned with item identifiers.

The output of this step is a set of item feature vectors ready for use in model training or inference.

### Step 7

The server constructs training data for an inference model by combining user feature vectors, context feature vectors, and item feature vectors with selection history information. The input of this step is feature data from Step 5, item feature data from Step 6, and selection history records.

The server creates positive training examples for user-item-context tuples where the user selected or purchased the item, and negative training examples for tuples where the item was not selected.

The server packages these examples into mini-batches of numerical tensors suitable for neural network training.

The output of this step is a training dataset consisting of input tensors and corresponding target labels.

### Step 8

The server executes learning processing of the inference model using the training dataset. The input of this step is the training dataset generated in Step 7 and an initial set of model parameters.

The server performs forward propagation on each batch, computing predicted suitability scores for each user-item-context tuple using a multilayer neural network or another machine learning architecture.

The server calculates a loss value, such as cross-entropy loss or pairwise ranking loss, by comparing predicted scores with target labels.

The server computes gradients of the loss with respect to model parameters and updates the parameters using a gradient-based optimization algorithm.

The output of this step is a trained inference model with updated parameters that capture relationships among user features, context features, and item features.

### Step 9

The user operates the terminal to request a recommendation for an upcoming time or event.

The input of this step is the user's explicit request and any updated context such as a new event or change of location.

The terminal collects current context data, including time, approximate location, and event description, and sends this context data along with the user identifier to the server. The output of this step is a recommendation request message transmitted to the server.

### Step 10

The server receives the recommendation request message from the terminal and retrieves the latest personal information and environment information for the user.

The input of this step is the request message and the stored user-related and context-related data.

The server updates or recalculates feature vectors for the user and context if the request introduces new information, following the same preprocessing rules as in Step 5.

The server then generates a combined user-context feature vector to be paired with each candidate item feature vector.

The output of this step is a set of combined feature vectors representing potential matches between the user and each candidate item under the current context.

### Step 11

The server applies the trained inference model to the combined feature vectors to estimate suitability scores for each candidate clothing item or outfit combination.

The input of this step is the trained inference model from Step 8 and the combined feature vectors from Step 10.

The server performs forward propagation only, without parameter updates, to compute a predicted score for each candidate.

The server ranks the candidates in descending order of predicted score and selects a subset of top-ranking candidates as clothing candidates.

The output of this step is a list of clothing candidates with associated suitability scores.

### Step 12

The server organizes selected clothing candidates into outfit sets and associates purchase route information with each set.

The input of this step is the list of clothing candidates and product catalog metadata.

The server groups items into coherent outfits according to predefined rules (for example, one top, one bottom, optional outerwear, and footwear) and checks availability in online and offline channels.

The server attaches electronic transaction routes such as online purchase URLs and physical store guidance routes such as store addresses and map links to each outfit set.

The output of this step is a structured representation of outfit sets including item details, prices, and purchase route information.

### Step 13

The server constructs a prompt sentence for a generative AI model using the estimation result and context information.

The input of this step is the selected outfit sets, the user's feature summary, and the current environment information.

The server generates textual descriptions of the user's body type, preferences, context (e.g., weather and event), and the main attributes of each selected outfit.

The server embeds this information into a prompt sentence that specifies the role of the generative AI model, the content to be described, and constraints on tone and length.

The output of this step is at least one prompt sentence configured for submission to the generative AI model.

### Step 14

The server transmits the prompt sentence to a generative AI model and receives natural-language proposal information in response.

The input of this step is the prompt sentence generated in Step 13 and the parameters of the generative AI model.

The server converts the prompt sentence into model-specific token sequences and sends these tokens to the generative AI model via an interface or an external service.

The generative AI model generates output token sequences that the server reconstructs into natural-language text describing the recommended outfits and their suitability.

The output of this step is proposal information in natural-language form, such as an explanation text tailored to the user and context.

### Step 15

The server post-processes the proposal information and prepares display data for the terminal.

The input of this step is the raw generated text from Step 14 and the outfit set data from Step 12.

The server checks that the proposal information meets specified constraints, such as maximum length and presence of essential elements (e.g., mention of weather and body type), and removes or replaces any undesired phrases according to predefined rules.

The server combines the validated proposal information with outfit images, prices, item names, and purchase route information into a response payload.

The output of this step is a complete display dataset ready to be sent to the terminal.

### Step 16

The server sends the display dataset to the terminal via the communication network.

The input of this step is the prepared response payload from Step 15 and transmission parameters such as destination address and protocol settings.

The server encapsulates the display dataset in a message format and transmits the message through the network interface.

The output of this step is a response message delivered to the terminal.

### Step 17

The terminal receives the response message from the server and renders the recommendation to the user.

The input of this step is the display dataset contained in the server's response.

The terminal parses the dataset, decodes item images, and constructs user interface elements that show outfit sets, descriptions, and purchase options.

The terminal displays the proposal information text generated by the generative AI model alongside the corresponding outfit images and purchase buttons.

The output of this step is a graphical presentation on the terminal display that the user can view and interact with.

### Step 18

The user examines the displayed outfits and the proposal information and performs a selection operation.

The input of this step is the visual and textual information presented on the terminal.

The user selects one or more outfits or items for further action, such as adding to a cart or marking as favorite.

The terminal records the selection by capturing identifiers of selected outfits, timestamps, and related context, and then sends this selection result to the server.

The output of this step is a selection result message transmitted from the terminal to the server.

### Step 19

The server receives the selection result and updates selection history information in the information management apparatus.

The input of this step is the selection result message from Step 18 and existing selection history records.

The server appends a new selection record containing the user identifier, selected item identifiers, context information, and optionally the prompt sentence and proposal information used.

The server stores this record in the selection history table, making it available for future training of the inference model.

The output of this step is an updated selection history dataset.

### Step 20

The server periodically reuses the updated selection history information in learning processing of the inference model.

The input of this step is the expanded selection history dataset along with existing feature data and model parameters.

The server extends the training dataset with new user-item-context examples reflecting recent behavior and retrains or fine-tunes the inference model by repeating the learning procedure of Step 8.

The server thereby refines the model parameters to improve prediction accuracy for future recommendations under similar contexts.

The output of this step is an updated inference model that more accurately reflects current user preferences and behavior patterns.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional recommendation systems that employ machine learning or rules-based engines often operate in a pipeline where user data is analyzed to directly output item identifiers or simple ranked lists. Such systems typically lack an intermediate, semantically rich representation that can flexibly describe user context, environment, and intent, and therefore must be re-implemented or heavily customized whenever new recommendation logic or presentation formats are needed. Furthermore, conventional systems that incorporate large generative AI models generally use manually crafted, static prompts that are not systematically derived from structured user and environment data, which leads to unstable output quality, difficulty in debugging, and inefficient utilization of computing resources. In many deployments, the server must aggregate heterogeneous user information such as body characteristics, preferences, behavior history, schedule information, and emotion state information, together with environmental information such as weather conditions and time. Existing architectures frequently treat these data sources in isolation, and do not provide an integrated, machine-executable mechanism to transform them into optimized prompt sentences for a generative AI model. As a result, server-side processing becomes fragmented: (i) data preprocessing is ad hoc, (ii) the generative AI model output is weakly constrained, and (iii) the mapping from generated natural language back to concrete article records is error-prone and computationally inefficient.

Additionally, in typical e-commerce or content recommendation platforms, a server that uses a generative AI model to produce human-readable suggestions often leaves the task of linking those suggestions to concrete, purchasable articles to a separate subsystem or even to manual curation. This separation causes redundant data transfers, increases latency, and complicates logging and feedback for model improvement. It also complicates the design of user interfaces on terminal devices, because the natural language text and the underlying article information are generated and managed by different components and cannot be easily synchronized or updated.

Therefore, there is a need for an improved computer-implemented technique that, within a unified server-side architecture, (i) systematically acquires and preprocesses user and context information into feature data, (ii) programmatically generates prompt sentences for a generative AI model based on those feature data, (iii) invokes the generative AI model and parses its proposal information, (iv) automatically maps the proposal information to concrete article information stored in a data storage, and (v) generates presentation data including purchase-related operation elements for terminal devices. Such a technique should reduce developer burden, improve stability and controllability of generative AI outputs, lower end-to-end latency, and provide a better basis for logging and retraining, thereby achieving a concrete improvement in the functioning of computer systems that implement recommendation and purchase flows.

The specific processing by the specific processing unit 290 of the data processing device 12 in Application Example 2 is realized by the following means.

The present invention provides a server comprising a processor and a memory storing instructions, the processor being configured to acquire user information by receiving, from a terminal device via a communication network, personal data of a user, and further acquire context information including at least environmental information related to a use situation; preprocess the acquired user information and the acquired context information to generate feature data by performing at least one of missing-value completion, normalization, categorization, and extraction of attribute information; generate, based on the feature data and the user information, a prompt sentence for input to a generative AI model, the prompt sentence describing the user information, the context information, and an instruction for causing the generative AI model to generate proposal information; transmit the prompt sentence to an internal or external generative AI model via the communication network and acquire, as the proposal information, a natural language explanation sentence and component information of an article generated by the generative AI model in response to the prompt sentence; analyze the proposal information to extract attribute information related to an article including at least one of apparel and merchandise, and identify concrete article information by searching article information stored in an article information storage based on the extracted attribute information; generate presentation data by associating the explanation sentence and the concrete article information with each other and including an operation element for a purchase operation; and transmit the presentation data to the terminal device so that the terminal device presents the proposal information and the concrete article information to the user and, in response to a selection operation received from the terminal device, generates and transmits access information to a purchase screen corresponding to at least part of the concrete article information. This enables a unified, machine-controlled pipeline in which heterogeneous user and context data are transformed into optimized prompt sentences, processed by a generative AI model, and automatically bound back to concrete article records, thereby improving the technical operation of the server by stabilizing generative outputs, reducing processing latency, simplifying integration with terminal interfaces, and providing richer, more structured logs for continuous model improvement.

The term “user information” refers to data that characterizes an individual user, including but not limited to body characteristic information, preference information, behavior history information, schedule information, and emotion state information.

The term “context information” refers to data representing circumstances surrounding use of the system, including but not limited to environmental information such as weather condition information, time information, and event-related information.

The term “environmental information” refers to data indicating physical or temporal conditions external to the user, such as weather, temperature, precipitation, time of day, and season.

The term “feature data” refers to structured data generated by preprocessing raw user information and context information, including normalized values, categorized labels, encoded attributes, and other derived representations suitable for machine processing.

The term “preprocess” refers to performing one or more operations such as missing-value completion, normalization, categorization, noise reduction, and attribute extraction on raw data to generate feature data.

The term “prompt sentence” refers to a natural language or semi-structured text string that describes user information, context information, and an instruction for generating a proposal, and that is used as input to a generative AI model.

The term “generative AI model” refers to an information processing model that generates output data, such as natural language text, based on input data including a prompt sentence, and that is typically implemented as a machine-learned model such as a neural network.

The term “proposal information” refers to data generated by the generative AI model in response to a prompt sentence, including at least a natural language explanation sentence and component information of an article.

The term “article” refers to an object that can be recommended or purchased through the system, including but not limited to apparel, accessories, and other merchandise. The term “attribute information” refers to one or more properties extracted from proposal information or from stored records, such as category, style, size, color, material, function, or usage scene of an article.

The term “concrete article information” refers to detailed information about a specific article instance stored in an article information storage, including identifiers, images, prices, sizes, and purchase URLs.

The term “article information storage” refers to a data storage resource, such as a database or index, that stores article-related records including attributes, identifiers, and purchase-related information.

The term “presentation data” refers to data generated for transmission to a terminal device, including proposal information, concrete article information, and layout or control information configured to cause the terminal device to present a user interface.

The term “operation element” refers to a user interface component, such as a button, link, or icon, that is displayed on the terminal device and is configured to receive a user operation related to actions such as purchase or detail viewing.

The term “purchase operation” refers to a sequence of user actions initiated on the terminal device for acquiring an article, including at least selection of an article and transition to a purchase screen.

The term “access information” refers to information, such as a uniform resource locator or endpoint identifier, that enables a terminal device to access a purchase screen or a transaction-processing resource corresponding to an article.

The term “purchase screen” refers to a user interface screen provided by a transaction system or commerce system, through which a user can input necessary data and complete a purchase of an article.

The term “terminal device” refers to an information processing apparatus operated by a user, such as a smartphone, tablet, personal computer, or wearable device, that is configured to communicate with the server and present user interfaces.

The term “communication network” refers to a wired or wireless data communication infrastructure, including the internet or other packet-based networks, over which the server and the terminal device exchange data.

The term “natural language explanation sentence” refers to one or more sentences in a human language describing reasons, contexts, or characteristics of a recommendation generated by the generative AI model.

In one embodiment, a server cooperates with one or more terminal devices operated by a user to provide article recommendations based on a generative AI model and a dynamically generated prompt sentence. The server includes at least one processor, a memory, a communication interface, and one or more storage units such as a relational database and an object storage. The terminal includes at least one processor, a memory, a display device, input devices, and a communication interface. The user operates the terminal to provide input data and to view recommendation results.

Server executes a program stored in the memory to implement the functions described below. Server runs an operating system such as a general-purpose server operating system and an application stack including a web server, an application framework, and a database management system. Server uses specific software components such as a relational database (for example, a structured query language database), a numerical computation library (for example, a matrix operation library), a machine learning framework (for example, a deep learning library such as TensorFlow or PyTorch), and a generative AI model execution environment (for example, a transformer-based language model backend). Server stores article information, user information, and logs in database tables and index structures, and maintains trained model parameters in a model storage.

Server acquires user information by receiving personal data from the terminal. Server stores, for each user, records including body characteristic information (such as height, weight, body shape type), preference information (such as favored styles, colors, brands), behavior history information (such as past purchase logs, click logs, and rejection logs), schedule information (such as event types and planned dates), and emotion state information (such as “joy”, “sadness”, “nervousness” inferred at past sessions). Server also acquires context information by accessing external services and internal timekeeping. Server obtains weather condition information by calling an external weather service through the communication interface using the user's location and the planned date. Server obtains time information from the system clock. Server may store environmental attributes such as temperature, precipitation probability, and time of day in a context information storage.

Server preprocesses the acquired user information and context information using a data processing module implemented with a numerical computation library. Server converts raw numerical and categorical values into feature data suitable for machine processing. Server performs missing-value completion by filling in absent values with means, medians, or user-specific historical values. Server performs normalization by scaling numerical attributes, such as height and temperature, into a fixed range (for example, between 0 and 1) using min-max scaling or standardization. Server performs categorization by mapping raw text labels, such as “smart casual” or “street”, to enumerated category identifiers. Server extracts attribute information by computing features such as “event type” (for example, business, date, leisure), “recommended style type” (for example, formal, casual, sporty), and “color tone type” (for example, bright, neutral, dark), based on combinations of user and context attributes. Server stores the resulting feature vectors as records in a feature data table, enabling later reuse and analysis.

Server generates a prompt sentence for a generative AI model based on the feature data and the user information. Server constructs this prompt sentence as a natural language text sequence. Server uses a prompt generation module that applies deterministic and rule-based transformations to the feature data. Server arranges the information into sections (for example, “User profile: . . . ”, “Event: . . . ”, “Weather: . . . ”, “Instruction: . . . ”) and incorporates constraints such as item types, style boundaries, and color tones. Server uses a fixed prompt template to enforce consistent structure, which improves the determinism and stability of generative outputs. Server thus generates, for example, a text such as:

“User profile: 29-year-old woman, slim body type, prefers casual and feminine styles. Event: dinner date at an Italian restaurant tomorrow evening. Weather: clear, 22° C. Please use this information to propose a complete smart-casual outfit including top, bottom, shoes, and optional accessories, with bright and cheerful colors. Output a short explanation and a structured list of items.”

Server may generate different prompt sentences depending on emotion state and context. For a user who prefers casual style and has an outdoor activity planned in rainy weather, server may generate:

“User profile: 32-year-old man, average build, prefers casual style and neutral colors. Event: meeting friends at a café tomorrow afternoon. Weather: rainy and 15° C. Please propose a complete casual outfit that is comfortable and suitable for a rainy day, including top, bottom, outerwear, and shoes, and explain the reasoning in a friendly tone.”

Server transmits the prompt sentence to a generative AI model. Server uses an internal language model execution engine or an external generative AI model service accessible over a communication network. Server provides the prompt sentence, model identifier, inference parameters such as temperature, top-k or top-p sampling thresholds, and a maximum output token length. The generative AI model is, in one embodiment, a transformer-based neural network that comprises multiple layers of self-attention and feed-forward networks. The model has been trained on large-scale text corpora and optionally fine-tuned using domain-specific data such as fashion descriptions and product catalogs.

Server receives, from the generative AI model, proposal information including a natural language explanation sentence and component information of an article. The model generates, for instance, text describing recommended items, such as “a white blouse, light blue high-waist jeans, a beige trench coat, and white sneakers,” together with an explanation like “This outfit matches your joyful mood and the mild evening weather, while keeping a smart-casual appearance suitable for a dinner date.” Server parses the output text using a natural language parsing module. Server tokenizes the text, applies part-of-speech tagging, and identifies item-like phrases by sequence labeling or pattern matching. Server extracts attribute information for each component, including category (top, bottom, outerwear, shoes, accessory), color (white, beige, navy), material hints (cotton, leather, waterproof), and style descriptors (casual, smart-casual, sporty, feminine).

Server identifies concrete article information by searching an article information storage using the extracted attribute information. Server maintains a product catalog in a database, with tables containing article identifiers, category codes, color codes, size availability, material types, brand codes, and purchase URLs. Server generates structured queries that reflect the extracted attributes and conditions derived from the feature data, such as size constraints and price ranges. Server executes these queries against the article information storage, possibly using an index structure or search engine for efficient retrieval. Server ranks the candidate articles using a ranking function that may combine similarity scores between the extracted attributes and stored attributes, historical purchase likelihoods from behavior history, and inventory status. Server selects one or more concrete articles for each recommended component and assembles them into a recommended set.

Server generates presentation data that associates the natural language explanation sentence and the concrete article information. Server forms a response data structure that includes, for each recommended article, fields for an image reference, a title, a brief description, a price, a size label, and a purchase link. Server includes in the presentation data at least one operation element definition, such as a “Purchase” button or “View details” link, that the terminal will render as a selectable interface component. Server then transmits the presentation data to the terminal via the communication interface.

Terminal receives the presentation data and generates a user interface based on the included structures. Terminal uses its display device and graphical user interface framework to render the natural language explanation sentence and the recommended articles. Terminal displays each article image, description, and price together with at least one operation element. Terminal may also display additional controls, such as filters or refresh controls, but the core display elements correspond directly to the presentation data defined by the server.

User views the proposed outfit or article list on the terminal and may perform selection operations. User may tap, click, or otherwise activate the operation elements for one or more articles. Terminal detects the selection operation and transmits selection information, including article identifiers and the type of operation, back to the server. Server receives the selection information and generates access information to a purchase screen corresponding to the selected article. Server may construct a uniform resource locator or an endpoint identifier for a commerce platform, embedding the article identifier and session information. Server then transmits the access information to the terminal so that the terminal can open a purchase screen. Terminal receives the access information and invokes a browser or an embedded web view to display the purchase screen provided by a transaction system. User can input payment information, confirm the purchase, and complete the transaction.

Server logs, in association with the feature data and the prompt sentence, the proposal information generated by the generative AI model, the concrete article information presented, and the user's selection and purchase behavior. Server stores these logs in a log storage. Server later uses these logs to retrain or fine-tune machine learning components and to refine the prompt generation rules. Server can, for example, learn that certain prompt structures lead to higher conversion rates or lower user bounce rates, and adapt the rules to emphasize or de-emphasize certain descriptors.

In one technical variant, server includes an additional model to optimize the prompt sentence itself. Server trains a secondary model that receives feature data and outputs adjustments to prompt templates, such as selecting between different instruction phrasings or specifying the number of items to recommend. Server optimizes this secondary model using reinforcement learning or supervised learning based on historical success metrics. This structure enables server to dynamically tune prompts in a way that human operators cannot efficiently achieve, thereby improving the performance of the generative AI model without repeatedly redesigning the overall architecture.

In another embodiment, server implements an internal deep learning model for mapping feature data directly to article attributes, and then uses the generative AI model primarily for human-friendly explanations. Server can combine a discriminative model that predicts item categories and colors with the generative model that verbalizes the recommendation context. This separation of concerns enables server to control critical content paths with deterministic or probabilistic models while reserving the generative AI model for narrative purposes. The association between explanation and concrete article information is maintained at the server, leading to consistent and synchronized user interfaces.

Server improves computer technology in multiple ways. By standardizing the structure and content of the prompt sentence based on formally defined feature data, server reduces the variance and unpredictability of generative outputs, thereby reducing post-processing load and network retransmissions due to errors. By using feature extraction and rule-based prompt assembly, server reduces the overall token length and unnecessary redundancy in prompts, improving inference latency and throughput for the generative AI model. By performing attribute extraction and article retrieval inside the same server process and data layer that generated the prompt, server minimizes cross-system communication, reduces serialization overhead, and avoids repeated parsing of similar data. These mechanisms lead to reduced end-to-end response time and lower computational and communication overhead compared to systems that rely on loosely coupled and manually driven prompt definitions.

Server also improves accuracy and robustness of the recommendation process. The feature-based prompt generation, combined with attribute-based retrieval from an article information storage, creates a closed loop in which generative suggestions are grounded back to concrete articles that satisfy technical constraints (for example, size availability, weather appropriateness, material requirements). Because server constrains the search space using structured attributes derived from both user information and context information, the probability that recommended items violate constraints is reduced, which improves precision and decreases error rates in the recommendation outputs.

Server uses specific neural network architectures and training procedures. For example, server may implement a multi-layer perceptron or a sequence model using a deep learning framework to map feature vectors to probability distributions over article categories or styles. Server defines a loss function, such as cross-entropy between predicted and actual purchased categories, and uses gradient-based optimization (for example, stochastic gradient descent with momentum or adaptive methods) to update weights. Server may perform data augmentation by randomly perturbing context attributes within realistic bounds (for example, small temperature changes) to improve model generalization. These technical measures at the model level contribute to improved computational performance and reliability.

Server differs from generic human workflows or simple automation because server applies non-obvious, machine-optimized transformations to structured and unstructured data, uses deep neural network-based models to produce semantically rich intermediate outputs, and uses deterministic rule-based logic to bind those outputs to concrete item records in a scalable, low-latency manner. Server enforces a precise data flow and module composition, whereby user and environmental data are translated into feature data, then into a prompt sentence, then into proposal information, and finally into concrete article information and presentation data. This layered architecture is not merely a direct computerization of a human stylist's reasoning, but rather is designed to exploit the statistical and structural advantages of machine learning and generative modeling in combination with high-speed data retrieval and user interface control.

Terminal can be implemented in various forms, such as a smart phone, a tablet, a wearable device, or a desktop computer. Terminal executes an application or a web client that communicates with the server using secure protocols. Terminal uses local caching of images and partial data to reduce network usage and latency. Terminal can implement adaptive layouts to show more items on large screens and fewer items on small screens, while preserving the association between the explanation sentence and the concrete article information by following the presentation data structure defined by the server.

In other embodiments, server can support multiple generative AI models or different model configurations for different domains, such as apparel, accessories, or other merchandise. Server can route prompt sentences to different models based on a domain identifier or based on the extracted event type. Server may also support fallback strategies, in which a smaller, faster language model is used when system load is high, or when the available feature data are limited. This flexibility in model selection and prompt routing contributes to scalability and resilience of the system.

In addition, server can provide diagnostic interfaces that reveal which feature data contributed to certain parts of the prompt sentence and which attributes led to selection of particular articles. This transparency assists in debugging and tuning of the system and allows operators to refine data processing and modeling strategies without rewriting large portions of code.

Through these embodiments, the server, the terminal, and the user cooperate to realize a concrete implementation of a generative AI-based recommendation system in which the generative AI model, the prompt sentence, and the article information storage are tightly integrated. The system thereby improves not only user experience but also the underlying performance and operability of the computer systems that execute the recommendation and purchase processing.

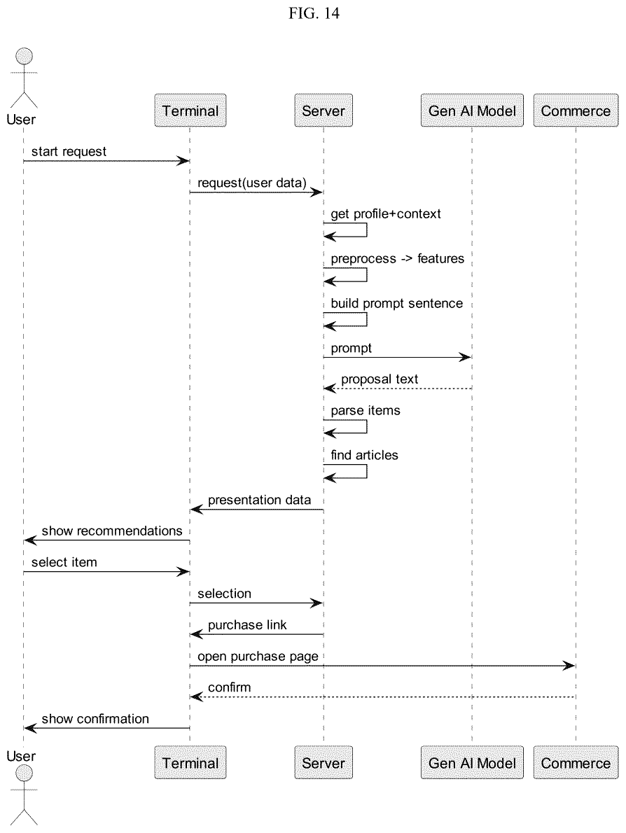

The following describes the processing flow using FIG. 14.

### Step 1

User operates the terminal to initiate a recommendation request.

User launches an application or web client on the terminal and selects a function such as “Suggest today's outfit” or “Suggest products.” User enters personal data (for example, body size, style preferences, budget), contextual data (for example, planned event, date and time, location), and optionally emotional or preference notes in text form.

Input: User taps buttons and inputs text or selections into UI components on the terminal. Processing: Terminal validates required fields, converts the entered values into a structured data object (for example, a JSON object with fields such as user_id, event_type, date, location, preferences), and attaches device and session identifiers.

Output: Terminal sends the structured request data to the server via a secure communication protocol.

### Step 2

Server receives the request and authenticates the user.

Server accepts the incoming request from the terminal through a network interface and checks authentication tokens or session keys.

Input: Server receives a structured request object containing user_id, personal attributes, event specification, location, and other parameters.

Processing: Server verifies the validity of session information and parses the request payload into internal variables. Server rejects or flags the request if authentication fails or required fields are missing, and otherwise continues processing.

Output: Server produces an internal context object that encapsulates the parsed request data for subsequent processing steps.

### Step 3

Server acquires stored user information and context information.

Server queries internal databases and external services to enrich the context object.

Input: Server uses the user_id and other identifiers contained in the context object.

Processing: Server executes database queries on user profile tables to obtain stored body characteristics, long-term preferences, and behavior history. Server calls external services, such as a weather service, using the location and date to get weather condition data. Server reads system time to obtain current time information. Server merges these data into the context object, updating or overriding fields as necessary.

Output: Server produces an enriched context object that includes current and historical user information and environment-related context information.

### Step 4

Server preprocesses user and context data to generate feature data.

Server transforms heterogeneous raw values into feature vectors suitable for algorithmic processing.

Input: Server takes the enriched context object containing numeric values (for example, age, temperature), categorical labels (for example, style, event type), and textual notes.

Processing: Server runs a preprocessing module implemented with a numerical library. Server fills missing values using default or statistically derived values. Server normalizes numeric fields (for example, scaling height, age, and temperature). Server encodes categorical fields into numeric codes or one-hot vectors. Server derives additional attributes, such as event_type_code, recommended_style_type, and color_tone_type, using rule-based mappings and combinations of fields.

Output: Server generates feature data, represented as one or more fixed-length vectors and structured attributes, and stores them with a reference to the current request.

### Step 5

Server generates a prompt sentence for a generative AI model.

Server constructs a natural language text string describing the user and context, and specifying instructions.

Input: Server uses the feature data vectors and structured attributes (including event type, style type, color tone type) along with raw descriptive user information.

Processing: Server applies a prompt generation module that inserts these values into predefined text templates. Server organizes the information into segments such as “User profile,” “Event,” “Weather,” and “Instruction.” Server may select one of several templates based on event_type_code or recommended_style_type. Server concatenates sentences in a fixed sequence, ensuring that necessary constraints (for example, item categories to include, color tone restrictions) are explicitly stated.

Output: Server produces a prompt sentence, such as “User profile: 32-year-old man, average build, prefers casual style and neutral colors. Event: meeting friends at a café tomorrow afternoon. Weather: rainy and 15° C. Please propose a complete casual outfit that is comfortable and suitable for a rainy day, including top, bottom, outerwear, and shoes, and explain the reasoning in a friendly tone.”

### Step 6

Server invokes the generative AI model using the prompt sentence.

Server sends the prompt to an internal or external generative AI model service and obtains proposal information.

Input: Server prepares an inference request containing the prompt sentence, the model identifier, and model parameters (for example, temperature, maximum token count).

Processing: Server transmits the request to the generative AI model over a communication interface. The generative AI model processes the prompt using a transformer-based neural network: the model converts the prompt into token embeddings, applies multiple layers of self-attention and feed-forward transformations, and sequentially generates output tokens according to sampling parameters. Server receives the generated output text stream and reconstructs it into one or more sentences.

Output: Server obtains proposal information, including at least a natural language explanation sentence and item descriptions of article components, as a text string.

### Step 7

Server analyzes proposal information to extract attribute information.

Server processes the generated text to identify article components and their attributes. Input: Server uses the proposal information string, including explanation and item descriptions.

Processing: Server runs a parsing module with natural language processing functions. Server tokenizes the text into words and phrases, identifies phrases that match patterns of clothing or article names, and uses tagging models or rules to assign roles (for example, top, bottom, outerwear, shoes, accessories). Server extracts attributes such as color words (for example, “white,” “navy”), material hints (for example, “waterproof,” “cotton”), and style descriptors (for example, “smart-casual,” “comfortable”). Server organizes these attributes into structured records, one record per proposed item category.

Output: Server generates attribute information data structures specifying, for each proposed component, the category type, color, optional material, and style properties.

### Step 8

Server identifies concrete article information from an article information storage. Server searches a product catalog using the extracted attributes to find matching articles.

Input: Server uses attribute information records together with user-specific constraints derived from the feature data (for example, size, budget, preferred brands).

Processing: Server formulates database queries or search requests for each component, specifying category codes, color filters, size filters, and any extra constraints such as “waterproof” or “suitable for rainy weather.” Server executes these queries against an article information storage that contains structured records for all available articles. Server ranks the retrieved items using a scoring function that may weigh attribute similarity, historical purchase likelihood, and inventory status. Server selects one or more top-ranked articles for each component.

Output: Server produces concrete article information, including article identifiers, category codes, color codes, size options, image references, prices, and purchase URLs, grouped per component type.

### Step 9

Server generates presentation data for the terminal.

Server associates explanation text with concrete articles and prepares data for user interface rendering.

Input: Server uses the proposal information (including explanation text) and the concrete article information for each component.

Processing: Server builds a presentation data structure that binds the natural language explanation sentence to a set of article records. Server attaches to each article record display-relevant fields, such as image reference, title, description, and price. Server adds metadata describing layout preferences and defines operation elements such as “Purchase” or “Details” buttons to be displayed for each article.

Output: Server sends the presentation data to the terminal over the communication network as a response to the original request.

### Step 10

Terminal displays recommendations and receives user interaction. Terminal renders the user interface based on the presentation data and collects user selections.

Input: Terminal receives the presentation data that includes explanation text, article records, and definitions of operation elements.

Processing: Terminal parses the data and uses its graphical framework to draw the explanation sentence, article images, and associated text elements on the display. Terminal generates interactive components such as purchase buttons according to the operation element definitions. Terminal detects user interactions, such as taps or clicks on these components, and associates them with the corresponding article identifiers and operation types.

Output: Terminal sends a selection message to the server that includes the selected article identifier and the requested operation (for example, purchase initiation).

### Step 11:

Server generates and returns access information for a purchase screen.

Server prepares a link or endpoint to a commerce platform for the selected article.

Input: Server receives the selection message from the terminal, including article identifier and operation type.

Processing: Server verifies that the selected article is still available and constructs access information to a purchase screen, for example by embedding the article identifier and user session data into a uniform resource locator for the commerce system. Server may record the selection event in a log for later analysis.

Output: Server transmits the access information for the purchase screen back to the terminal.

### Step 12

Terminal opens the purchase screen and user completes the transaction.

Terminal transitions to a transaction interface using the received access information.

Input: Terminal receives the access information for the purchase screen associated with the selected article.

Processing: Terminal launches a web browser or in-app web view and navigates to the purchase screen using the access information. Terminal displays order details and input fields for shipping and payment data.

Output: User provides payment and shipping information through the purchase screen, and the commerce platform completes the transaction; terminal displays confirmation information to the user.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

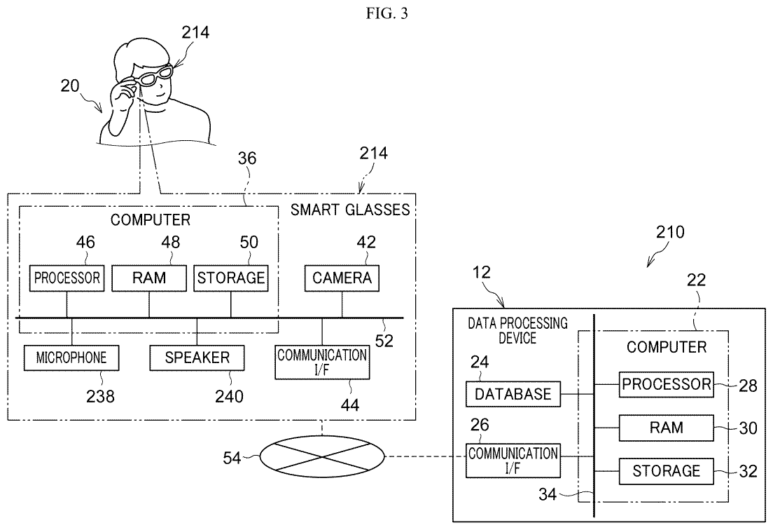

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

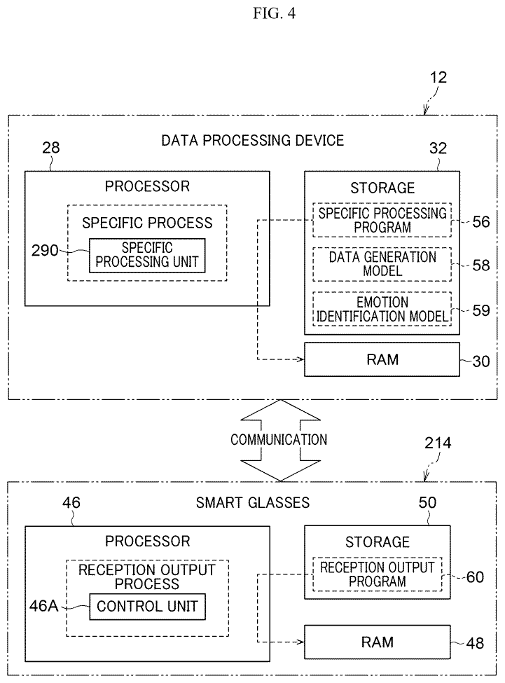

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

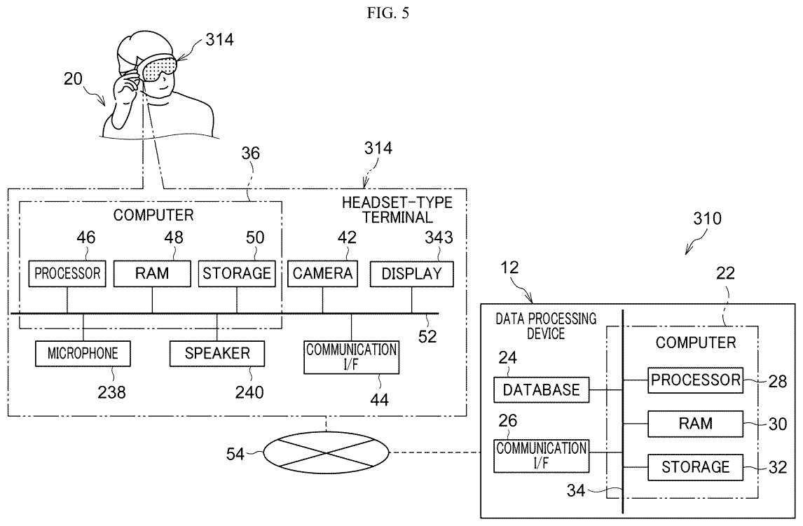

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

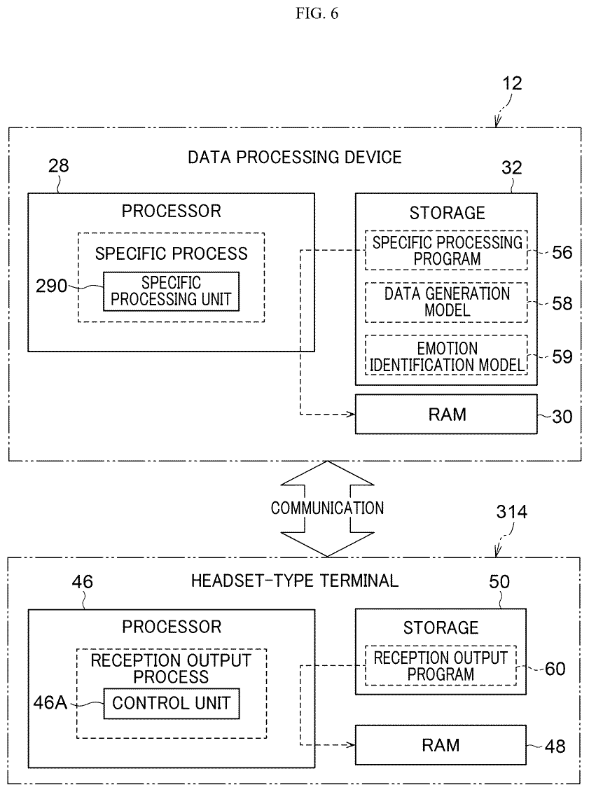

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

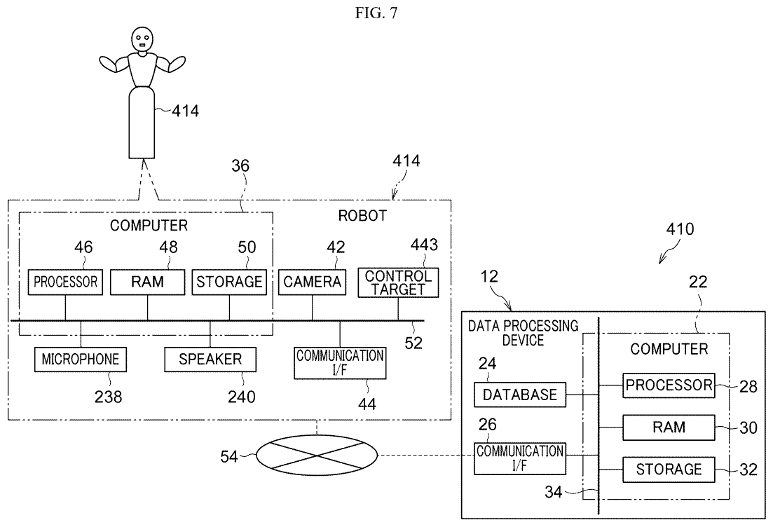

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

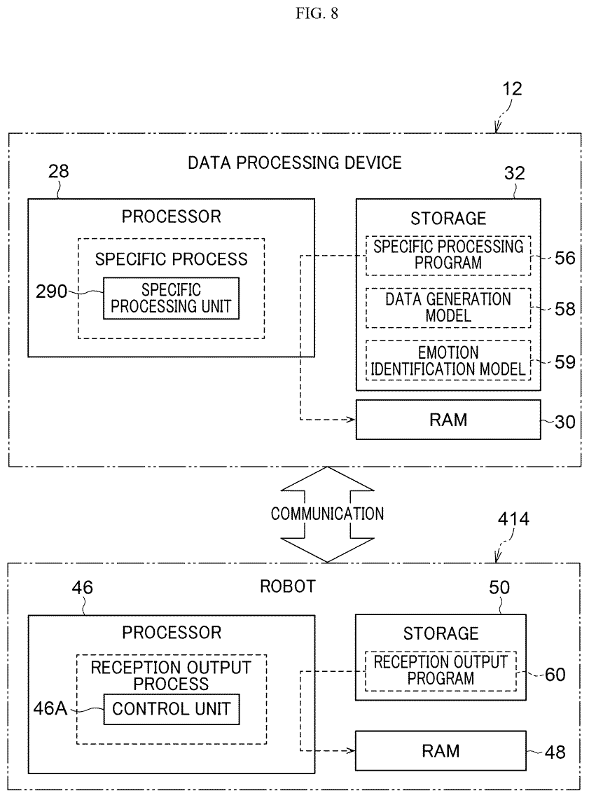

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

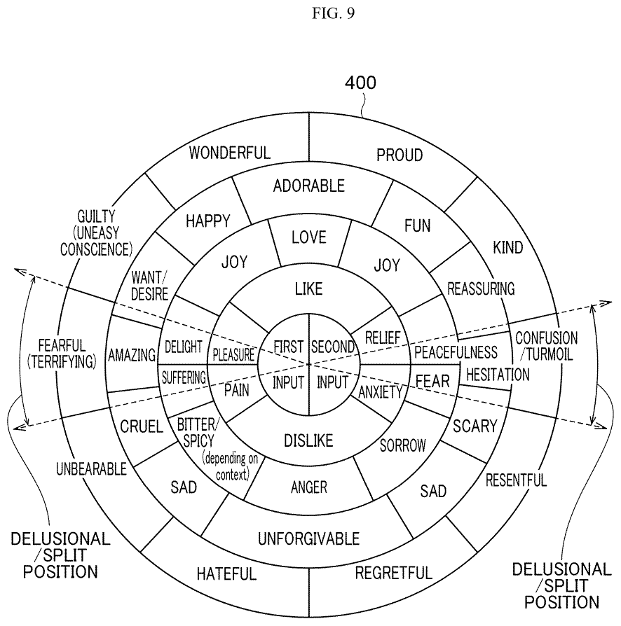

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

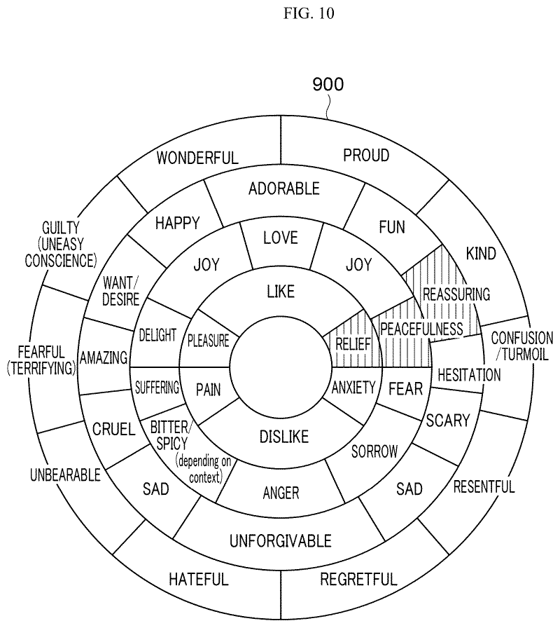

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor, a memory, and a communication interface,
wherein the processor is configured to
acquire, via a communication network, user attribute information including input information from a user and public information obtained through an external information providing apparatus, and store the user attribute information in the memory,
perform, by using a statistical processing program and a natural language processing program, normalization processing of character information, extraction processing of feature terms, and aggregation processing of occurrence frequency on the user attribute information stored in the memory to generate feature quantity information indicating preferences of the user,
construct, on a basis of the feature quantity information and by using template information and control conditions, a prompt sentence including a situation description relating to the user and proposal generation conditions, the prompt sentence being for input to a generative AI model,
transmit, via the communication interface, inquiry information including the prompt sentence to an information processing service that provides the generative AI model, and acquire, from the information processing service, proposal information generated in response to the prompt sentence, and
convert the proposal information into a display format corresponding to a terminal apparatus of the user and transmit the converted proposal information to the terminal apparatus via the communication network.

### Supplementary 2

The system according to supplementary 1,
wherein the processor is configured to
classify the user into a plurality of behavioral pattern categories by using the feature quantity information through rule-based processing or machine learning processing, and control configuration elements and an output format of the prompt sentence in accordance with the behavioral pattern categories.

### Supplementary 3

The system according to supplementary 1,
wherein the processor is configured to
include, in the prompt sentence, output specification information and constraint condition information for receiving an output result from the generative AI model in a structured data format, acquire the proposal information as the structured data format, perform filter processing and supplementary information addition processing on the structured data, and transmit the processed structured data to the terminal apparatus.

### Application Example 1

### Supplementary 1

A system comprising a processor,
wherein the processor is configured to
acquire personal information and user-generated information of a user, store in a storage device the user-generated information including input data transmitted from a terminal of the user and post data acquired via an application programming interface of a communication service, and associate the user-generated information with the personal information,
perform natural language processing on the user-generated information stored in the storage device to extract keyword information from the post data, and structure and store the keyword information as an internal representation in association with user attribute information,
encode the user attribute information and the keyword information as feature data, execute a trained recommendation algorithm that performs inference processing based on a combination of the feature data and product information, and generate recommendation candidate information,
acquire, via an application programming interface of an external information providing service, product information corresponding to the recommendation candidate information, and integrate the product information with the recommendation candidate information,
generate a prompt sentence for input to a generative information processing model on the basis of context information including the user attribute information, the keyword information, and the recommendation candidate information, input the prompt sentence and the recommendation candidate information to the generative information processing model, and cause the generative information processing model to generate explanation text information corresponding to each recommendation candidate,
generate presentation data including the explanation text information and the product information, and transmit the presentation data to the terminal of the user via a communication network, and
acquire browsing operation information and purchase operation information transmitted from the terminal of the user, store the browsing operation information and the purchase operation information as behavior history, and update training data for the trained recommendation algorithm on the basis of the behavior history.

### Supplementary 2

The system according to supplementary 1,
wherein the processor is configured to
standardize the post data, perform phrase extraction, importance calculation, and classification processing on the standardized post data to extract keyword information representing season information, movement information, activity information, and preference information, and store the keyword information in association with category information and weight information as part of the user attribute information.

### Supplementary 3

The system according to supplementary 1,
wherein the processor is configured to
generate the prompt sentence for input to the generative information processing model by summarizing feature information including body information, preference information, living environment information, time information, position information, event information, and the keyword information of the user, and product attribute information included in the recommendation candidate information, and by adding instruction information specifying a style, a length, and content requirements of explanation text to be generated.

### Example 2

### Supplementary 1

A system comprising a processor,
wherein the processor is configured to
acquire attribute information and behavior information from a user via a terminal device, and store the attribute information and the behavior information as personal information in an information management apparatus, and
read a plurality of types of information including the personal information and environment information from the information management apparatus, and generate feature data by performing data preprocessing including normalization of numerical information and encoding of categorical information, and
select an inference model for performing learning processing based on the feature data and past selection history information, and update the inference model by an information processing apparatus to calculate clothing candidates as an estimation result, and
generate a prompt sentence for input to a generative artificial intelligence model from the estimation result and context information including the environment information, and input the prompt sentence to the generative artificial intelligence model to cause the generative artificial intelligence model to generate proposal information in natural language, and transmit the clothing candidates and the proposal information together with purchase route information to the terminal device via a communication network, and present the clothing candidates and the proposal information to the user, and
acquire a selection result of at least one of the clothing candidates from the user, and record the selection result as the selection history information in the information management apparatus, and reuse the selection history information in the learning processing of the inference model.

### Supplementary 2

The system according to supplementary 1,
wherein the processor is configured to
generate the prompt sentence based on body information, preference information, living condition information, season information, position information, time information, and event information included in the personal information, and structure the prompt sentence so as to instruct the generative artificial intelligence model regarding content of a style proposal, a representation format, and an amount of text.

### Supplementary 3

The system according to supplementary 1,
wherein the processor is configured to
generate, based on the estimation result, a plurality of outfit sets by combining a plurality of clothing elements, associate at least one of an electronic transaction route and a physical store guidance route as the purchase route information with each of the outfit sets, and generate display data including the outfit sets and the purchase route information so as to be transmittable to the terminal device.

### Application Example 2

### Supplementary 1

A system comprising a processor and a memory storing instructions,
wherein the processor is configured to
acquire user information by receiving, from a terminal device, personal data of a user, and acquire context information including at least environmental information related to a use situation,
preprocess the acquired user information and the acquired context information to generate feature data by performing at least one of missing-value completion, normalization, categorization, and extraction of attribute information,
generate a prompt sentence for input to a generative AI model, based on the feature data and the user information, the prompt sentence describing the user information, the context information, and an instruction for generating a proposal,
transmit the prompt sentence to an internal or external generative AI model via a communication network and acquire proposal information generated by the generative AI model in response to the prompt sentence,
analyze the proposal information to extract attribute information related to an article including at least one of apparel and merchandise, and identify concrete article information by searching article information stored in an article information storage based on the extracted attribute information,
generate presentation data by associating the proposal information and the concrete article information with each other, and transmit the presentation data to the terminal device so that the terminal device presents the proposal information and the concrete article information to the user, and
generate access information to a purchase screen corresponding to at least part of the concrete article information, in response to a selection operation received from the terminal device, and transmit the access information to the terminal device.

### Supplementary 2

The system according to supplementary 1,
wherein the processor is configured to
acquire, as the user information, at least body characteristic information, preference information, behavior history information, schedule information, and emotion state information of the user, acquire, as the context information, at least weather condition information and time information, and generate, as the feature data and the prompt sentence, information including at least an event type, a recommended style type, and a color tone type.

### Supplementary 3

The system according to supplementary 1,
wherein the processor is configured to
acquire, as the proposal information, a natural language explanation sentence and component information of the article generated by the generative AI model, generate the presentation data by associating the explanation sentence with the concrete article information, and include, in the presentation data, an operation element for purchase operation to be displayed by the terminal device.

What is claimed is:

1. A system comprising:
circuitry configured to:
acquire, via a communication interface coupled to a packet-switched network, user attribute information including input data transmitted from a terminal device of a user and post data obtained from an external information providing apparatus via an application programming interface;
perform natural language processing on the post data to extract feature terms and compute occurrence frequency information for the extracted feature terms, thereby generating feature quantity information representing preferences and behavioral patterns of the user;
classify the user into one or more behavioral pattern categories based on the feature quantity information using at least one of rule-based processing or machine learning processing;
construct a prompt sentence for input to a generative neural network model by combining template information with the feature quantity information, the behavioral pattern categories, output specification information, and constraint condition information;
transmit inquiry information comprising the prompt sentence to an information processing service providing the generative neural network model and receive, from the information processing service, proposal information in a structured data format specified by the output specification information;
perform filter processing on the proposal information and supplementary information addition processing to generate enriched proposal data;
transmit, via the communication interface, the enriched proposal data converted into a display format to the terminal device; and
receive feedback information transmitted from the terminal device and update, based on the feedback information, at least one of the feature quantity information or parameters used in constructing subsequent prompt sentences.

2. The system according to claim 1, wherein the circuitry is configured to perform the natural language processing by applying tokenization, stop word removal, and lemmatization to the post data to produce normalized text sequences, and to match tokens in the normalized text sequences against a domain vocabulary to detect the feature terms.

3. The system according to claim 2, wherein the circuitry is configured to compute the occurrence frequency information by counting occurrences of each feature term per user over one or more time windows and computing co-occurrence metrics and temporal trend indicators, and to store the feature quantity information as feature quantity vectors indexed by feature type and time segment.

4. The system according to claim 1, wherein the user attribute information includes at least one of profile data representing physical characteristics of the user, preference data representing style or usage preferences of the user, and living environment data representing climate or lifestyle conditions of the user, and wherein the external information providing apparatus comprises a communication service that provides the post data via an application programming interface associated with the communication service.

5. The system according to claim 4, wherein the proposal information comprises recommendation items adapted to at least one of a body type parameter, a season parameter, a location parameter, or an event parameter associated with the user.

6. The system according to claim 1, wherein the circuitry is configured to classify the user into the behavioral pattern categories by applying a supervised learning model trained on historical feature vectors, the supervised learning model comprising at least one of a neural network classifier or a tree-based classifier, and to store the behavioral pattern categories in a behavioral pattern table linked to a user identifier.

7. The system according to claim 6, wherein the circuitry is configured to construct the prompt sentence by selecting a template from a plurality of templates based on the behavioral pattern categories, replacing placeholder tokens in the selected template with values derived from the feature quantity information and the behavioral pattern categories, and appending the output specification information and the constraint condition information to produce a fully constrained prompt sentence.

8. The system according to claim 7, wherein the output specification information specifies a structured data format having defined fields and enumerated list structure, and wherein the constraint condition information specifies at least one of a maximum number of items, geographic constraints, or preference constraints.

9. The system according to claim 1, wherein the circuitry is configured to perform the filter processing by iterating over items in the proposal information, comparing attributes of each item against constraint rules stored in a storage device, and discarding items that do not satisfy the constraint rules.

10. The system according to claim 9, wherein the circuitry is configured to perform the supplementary information addition processing by attaching to each item in the filtered proposal information at least one of a unique identifier, a link to a mapping service, a category tag, or a localization string, and to compute derived fields including at least one of estimated distance or predicted suitability scores.

11. The system according to claim 1, wherein the circuitry is configured to encode the user attribute information and the keyword information as feature data comprising at least one of one-hot encoded categorical vectors, normalized numerical attribute vectors, or keyword embedding vectors generated by a pre-trained word embedding model, and to concatenate the encoded vectors to produce a unified user feature vector.

12. The system according to claim 11, wherein the circuitry is configured to execute a trained recommendation algorithm comprising a neural network having a user tower and an item tower, to compute a relevance score for combinations of a user feature vector and a product feature vector using at least one of a dot product or cosine similarity, and to select recommendation candidates based on the relevance scores.

13. The system according to claim 12, wherein the circuitry is configured to update training data for the trained recommendation algorithm by storing browsing operation information and purchase operation information received from the terminal device as behavior history, and to periodically retrain the recommendation algorithm using the updated behavior history.

14. The system according to claim 1, wherein the circuitry is configured to acquire the post data from the external information providing apparatus by issuing requests specifying a user identifier and authentication data, to normalize character encoding of received post data, and to store the post data in a storage device with associated metadata comprising at least a source identifier and a timestamp.

15. The system according to claim 1, wherein the circuitry is configured to select a display format for the enriched proposal data based on capability information of the terminal device comprising at least one of screen size or supported interaction modes, and to transmit display-formatted data to the terminal device via the communication interface.

16. The system according to claim 1, wherein the circuitry is configured to estimate an emotional state of the user from at least one of voice data, text data, or interaction timing data received from the terminal device, and to adjust at least one of a tone parameter or a level of detail parameter of the prompt sentence based on the estimated emotional state.

17. The system according to claim 1, wherein the circuitry is configured to monitor a response latency of the generative neural network model and, when the response latency exceeds a threshold value, switch from a first generative neural network model having a first parameter count to a second generative neural network model having a second parameter count lower than the first parameter count.

18. A system comprising:
circuitry configured to:
acquire, via a communication interface coupled to a packet-switched network, user attribute information comprising input data from a terminal device and post data from an external information providing apparatus;
perform tokenization, stop word removal, and feature term extraction on the post data using a natural language processing program, and compute occurrence frequency vectors for the extracted feature terms to generate feature quantity information;
apply a machine learning classifier to the feature quantity information to assign one or more behavioral pattern categories to the user;
construct a prompt sentence by populating a template with the feature quantity information, the behavioral pattern categories, output specification information, and constraint condition information, and transmit the prompt sentence to a generative neural network model;
receive proposal information in a structured data format from the generative neural network model, perform filter processing and supplementary information addition processing on the proposal information, and transmit display-formatted enriched proposal data to the terminal device via the communication interface; and
receive feedback information from the terminal device and update parameters for subsequent prompt construction based on the feedback information.

19. The system according to claim 18, wherein the circuitry is configured to encode the user attribute information and the feature quantity information as feature data comprising concatenated profile feature vectors and keyword embedding vectors, and to execute a trained recommendation algorithm comprising a two-tower neural network to compute relevance scores for recommendation candidates.

20. A method comprising:
acquiring, via a communication interface coupled to a packet-switched network, user attribute information including input data transmitted from a terminal device of a user and post data obtained from an external information providing apparatus via an application programming interface;
performing natural language processing on the post data to extract feature terms and compute occurrence frequency information for the extracted feature terms, thereby generating feature quantity information representing preferences and behavioral patterns of the user;
classifying the user into one or more behavioral pattern categories based on the feature quantity information using at least one of rule-based processing or machine learning processing;
constructing a prompt sentence for input to a generative neural network model by combining template information with the feature quantity information, the behavioral pattern categories, output specification information, and constraint condition information;
transmitting inquiry information comprising the prompt sentence to an information processing service providing the generative neural network model and receiving, from the information processing service, proposal information in a structured data format specified by the output specification information;
performing filter processing on the proposal information and supplementary information addition processing to generate enriched proposal data;
transmitting, via the communication interface, the enriched proposal data converted into a display format to the terminal device; and
receiving feedback information transmitted from the terminal device and updating, based on the feedback information, at least one of the feature quantity information or parameters used in constructing subsequent prompt sentences.
